(19) United States
(12) Patent Application Publication
(10) Pub. No.: US 2001/0044729 A1
(43) Pub. Date: Nov. 22, 2001

(54) Automated complaint management system

(76) Inventor: Brenda Pomerance, New York, NY (US)

Correspondence Address: BRENDA POMERANCE, 260 WEST 52 STREET, APT 27B, NEW YORK, NY, 10019, US

(21) Appl. No.: 09/817,072

(22) Filed: Mar. 26, 2001

Related U.S. Application Data
(63) Continuation-in-part of application No. 09/793,687, filed on Feb. 26, 2001.
Application No. 09/793,687 is a continuation-in-part of application No. 09/543,049, filed on Apr. 5, 2000.
(60) Provisional application No. 60/203,705, filed on May 11, 2000.
(60) Provisional application No. 60/216,222, filed on Jul. 5, 2000.

(51) Int. Cl. G06F 17/60

(52) U.S. Cl. 705/1

(57) ABSTRACT

A complaint management system, also referred to as a disputes system, enables registered consumers to file a complaint against a merchant. During complaint preparation, the disputes system advises the consumer of relevant cases and other information, allows the consumer to vent their emotions, and prepares a well-formed complaint on behalf of the consumer. After the consumer approves filing of the complaint, the complaint is compared with the merchant's stored business rules. If the merchant's solution for the problem and the consumer's desired solution match, then the disputes system automatically forms an agreement. The disputes system monitors compliance with the agreement by the merchant and consumer. If the merchant has specified a business rule for the problem, but the merchant's solution for the problem and the consumer's desired solution differ, then the disputes system initiates automated mediation, automatically preparing an Answer comprising the solution from the merchant's business rule as the merchant's starting negotiating position. Alternatively, the complaint management system may automatically negotiate parameters of the proposed solution to improve customer satisfaction, and may enter the item complained of to at least one of a resale market and a refund competition If the merchant has not specified a business rule for the consumer's problem, then the disputes system initiates automated mediation, asking the merchant for his or her Answer to the consumer's complaint. At the conclusion of the case, the disputes system automatically prepares an anonymized case summary, and adds the anonymized case summary to a database of anonymized case summaries.

The present application is a continuation-in-part of U.S. patent application Ser. No. 09/793,687, filed Feb. 26, 2001, which is a continuation-in-part of U.S. patent application Ser. No. 09/543,049, filed Apr. 5, 2000; U.S. provisional application Ser. No. 60/203,705, filed May 11, 2000; and U.S. provisional application Ser. No. 60/216,222, filed Jul. 5, 2000; the disclosure of each of these applications is hereby incorporated by reference.

### BACKGROUND OF THE INVENTION

The present invention relates to automated complaint management and dispute resolution, and more particularly, is directed to automated resolution of a complaint from a complainer against a party.

Credit card associations have procedures for resolving payment disputes. Due to the large volume of payment disputes, the procedures have been largely automated. Typically, a call center representative obtains payment dispute details from a cardholder via a telephone conversation, then enters the payment dispute details into a computer workstation.

The details of the dispute are compared by a computer system against automated rules for resolving disputes. If necessary to resolve the dispute, additional information is sought from the merchant involved in the dispute with the cardholder. Usually, the computer system recommends a resolution to a human staff member at the cardholder's issuing institution, and the human endorses the resolution; in many cases, the human endorsement is bypassed so that the computer system resolves the dispute without human aid.

The credit card association dispute resolution procedure is an arbitration, as a third party, i.e., not the cardholder or merchant, makes a decision that resolves the dispute. In many disputes, the third party performing the arbitration is a computer system.

If either the cardholder or the merchant is unhappy with the resolution of the dispute, and certain requirements are met, such as the dispute having at least a particular dollar value, then the dispute proceeds to human-directed arbitration.

The credit card dispute resolution process is available only when a credit card was used for payment. Furthermore, the cost of the dispute resolution process is very high, due to costs incurred when the cardholder's issuing institution and the merchant's acquiring institution are brought into a dispute between the cardholder and merchant. The cardholder is supposed to invoke the credit card dispute resolution process only after attempting to directly resolve the dispute with the merchant, but in many cases the direct resolution attempt does not occur because the merchant is not readily accessible or the cardholder wishes to avoid a direct confrontation with the merchant. Thus, the credit card dispute resolution process, while inefficient, is used when available because the alternative, cardholders fending for themselves, is worse. Online dispute resolution services exist, but all of these services use a human as the third party directing the conflict resolution. For example, a large auction site recommends that dissatisfied bidders use a particular one of these dispute resolution services. The dispute resolution service has a first fully automated phase, in which the dispute resolution service acts as a message switch facilitating direct negotiation by e-mail between buyers and sellers, and a second human-directed phase, in which a trained mediator mediates resolution of the dispute between the buyer and the seller.

In arbitration, the third party decides the dispute, whereas in mediation, decision making authority remains with the principals involved in the dispute and the third party helps the principals to reach an agreement.

The online dispute resolution services are all fairly expensive, as a trained human is involved in resolving each dispute. Furthermore, when a human is involved, delays are inevitable.

Shipping companies have recently introduced systems to make the return shipping channel more efficient. Usually, a merchant decides when return shipping is authorized, and the shipping company enables the merchant or the merchant's customer to locally print a return shipping label; this is particularly convenient for the customer when the merchant's account is used to pay for the return shipping. However, each merchant decides how to best employ the shipping company services, that is, the shipping companies specify the procedure for reverse shipping, but not the rules governing how reverse shipping is authorized.

Other online services exist for helping parties decide the monetary value of a settlement to a conflict. A typical scenario involves a party having a claim against an insurance company. The claimant and the insurance company each provide a series of settlement amounts, in confidence, to a computer system, and the computer system uses an algorithm to computer the settlement amount, if any. These services are useful when the only item being disputed is the dollar amount of the settlement.

Accordingly, there is room for improving the efficiency of dispute resolution.

### SUMMARY OF THE INVENTION

In accordance with an aspect of this invention, there is provided a method for automated resolution of a complaint from a complainer against a party. Lack of agreement is detected between the complainer and the party, and then automated mediation occurs between the complainer and the party to resolve the complaint, the mediation occurring without a human mediator.

During preparation of the complaint, relevant contextual information may be presented to the complainer. Based on information previously supplied by the party, what information is needed to detect lack of agreement may be automatically determined, and the needed information may then be automatically collected. A summary of processing of the complaint may be automatically prepared, the summary being anonymized and having at least two levels of information granularity.

In accordance with another aspect of this invention, there is provided a method for automated resolution of a complaint from a complainer against a party. Emotional detail information is automatically collected, and emotional state information for the complaint is automatically generated from the emotional detail information. The complaint is automatically compared with rules previously supplied by the party to detect whether there is a match between a solution desired by the complainer and solutions that the party agrees to.

In accordance with a further aspect of this invention, there is provided a method for automated resolution of a complaint from a complainer against a party. The complaint is automatically collected from the complainer, and when the complaint's desired solution does not match acceptable solutions specified in rules of the party, a complaint resolution offer is automatically generated on behalf of the party based on the acceptable solutions specified in the rules of the party.

In accordance with yet another aspect of this invention, there is provided a method for automated resolution of a complaint from a complainer against a party. An agreement resolving the complaint is obtained. Compliance by at least one of the complainer and the party with terms of the agreement is automatically monitored.

The compliance monitoring may include receiving compliance information from at least one of the complainer and the party, or receiving compliance information from an external source.

In accordance with another aspect of this invention, there is provided a method for managing a complaint. The complaint is automatically compared with merchant rules to obtain a proposed remedy having at least one parameter. The at least one parameter is automatically negotiated to improve consumer satisfaction.

Negotiating may include improving one of the parameters of the remedy in response to an indication from a consumer that consumer satisfaction might be improved by improving the parameter, and also may include automatically soliciting an explanation from the consumer as to why the consumer deserves parameter improvement beyond a predetermined value. An item specified in the complaint may be automatically submitted to at least one of a resale market and to a refund competition.

In accordance with a further aspect of this invention, there is provided a method for managing a complaint. The complaint is automatically compared with merchant rules to obtain a proposed remedy having at least one parameter. An item specified in the complaint is automatically entered to a refund competition when the proposed remedy is not satisfactory.

A description of circumstances justifying a refund of the price of the item specified in the complaint may be automatically received. A voting or ranking for a set of descriptions provided by other consumers may also be automatically received. The set of descriptions may be automatically selected according to an exposure procedure.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a block diagram of the environment in which the present invention is used;

FIG. 2 is a flowchart depicting part of setup for system 10;

FIG. 3A is a flowchart depicting the consumer registration portion of the setup process of FIG. 2;

FIG. 3B is a chart illustrating consumer registration record 210;

FIG. 4A is a flowchart depicting the merchant registration portion of the setup process of FIG. 2;

FIG. 4B is a chart illustrating merchant registration record 220;

FIG. 4C is a chart illustrating merchant public record 230;

FIG. 4D is a chart illustrating a business rule template;

FIG. 4E is a flowchart depicting entering business rules for a merchant;

FIG. 5 is a flowchart depicting operation of system 10 in one embodiment;

FIG. 6 is a flowchart depicting the consumer complaint preparation portion of the operation process of FIG. 5;

FIG. 7 is a flowchart depicting the comparing of a complaint with a merchant's business rules portion of the operation process of FIG. 5;

FIG. 8A is a flowchart depicting the automated mediation portion of the operation process of FIG. 5;

FIG. 8B is a chart illustrating the automated mediation procedure used in system 10;

FIG. 8C is a flowchart depicting preparation of a response in automated mediation;

FIG. 9 is a flowchart depicting the compliance portion of the operation process of FIG. 5;

FIG. 10A is a flowchart depicting the preparing an anonymized case summary portion of the operation process of FIG. 5;

FIG. 10B is a chart depicting detailed case record 1050;

FIG. 10C is a chart depicting anonymized case summary 1075;

FIG. 11 is a chart depicting operation of system 10 in another embodiment;

FIG. 12 is a chart depicting the negotiation portion of the operation process of FIG. 11;

FIG. 13 is a chart depicting resale market processing;

FIG. 14 is a chart depicting operation of a resale market;

FIG. 15 is a chart depicting refund competition processing; and

FIG. 16 is a chart depicting operation of a refund competition.

### DETAILED DESCRIPTION OF THE PREFERRED EMBODIMENTS

An automated complaint management system, also referred to as a disputes system, enables registered consumers to file a complaint against a merchant. During complaint preparation, the complaint management system advises the consumer of relevant cases and other information, allows the consumer to vent their emotions, and prepares a well-formed complaint on behalf of the consumer. After the consumer approves filing of the complaint, the complaint is compared with the merchant's stored business rules. If the merchant's solution for the problem and the consumer's desired solution match, then the complaint management system automatically forms an agreement. The complaint management system monitors compliance with the agreement by the merchant and consumer.

If the merchant has specified a business rule for the problem, but the merchant's solution for the problem and the consumer's desired solution differ, then the complaint management system initiates automated mediation, automatically preparing an Answer comprising the solution from the merchant's business rule as the merchant's starting negotiating position.

In some embodiments, the complaint management system automatically negotiates on behalf of the merchant, varying parameters of the remedies offered by the merchant to attain customer satisfaction.

If the merchant has not specified a business rule for the consumer's problem, then the complaint management system initiates automated mediation, asking the merchant for his or her Answer to the consumer's complaint.

During processing of the consumer's complaint, the complaint management system maintains and updates a detailed case record, including the business rules in effect when the complaint is filed, copies of all notices provided by the complaint management system to the parties, and copies of all communications to and from the parties. At the conclusion of the case, the complaint management system automatically prepares an anonymized case summary, and adds the anonymized case summary to a database of anonymized case summaries.

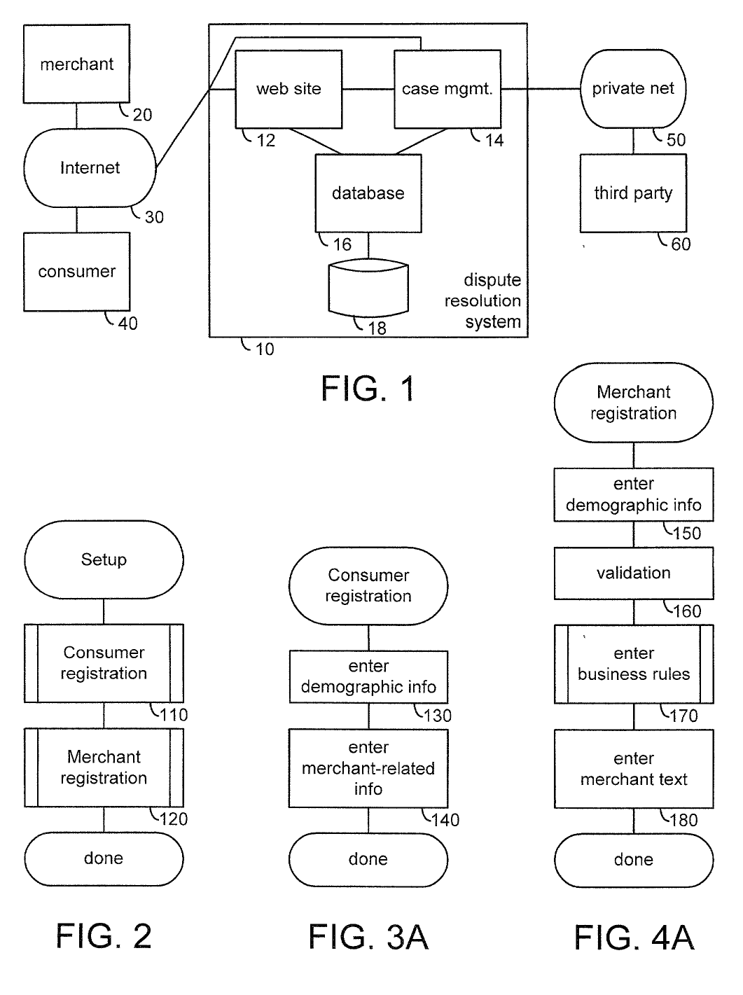

Referring now to the drawings, and in particular to FIG. 1, there is illustrated the environment in which the complaint management system is used.

FIG. 1 shows complaint management system 10 having web site 12, case management system 14, database system 16 and database 18. Each of web site 12, case management system 14 and database system 16 is adapted to communicate with the other two parts of complaint management system 10 to provide the functionality described in FIGS. 2-10. Web site 12 is adapted to receive and transmit information using Internet 30 according to hypertext transfer protocol. Case management system 14 is adapted to receive and transmit electronic mail (e-mail) using Internet 30. Database system 16 is adapted to maintain database 18, including receiving merchant and consumer registration information, and providing access to anonymized case summaries of processed cases and merchant public records.

Complaint management system 10 is coupled to Internet 30, or similar public communication network, and to private network 50. Merchant 20 and consumer 40 are coupled to Internet 40 via a conventional access method such as respective personal computers executing browser software coupled to respective Internet service providers. Third party 60 is shown as being coupled to private network 50. In some embodiments, third party 60 is coupled to Internet 30 in similar manner as merchant 20 and consumer 40. It will be understood that there are many merchants and consumers coupled to complaint management system 10 although only one instance of merchant 20 and one instance of consumer 40 are shown in FIG. 1.

Although there is only one instance of third party 60 shown in FIG. 1, it will be understood that many third parties may be coupled to complaint management system 10.

Generally, during a setup phase, consumers and merchants register with dispute system 10. During an operation phase, a consumer fills out a complaint with assistance from complaint management system 10. If the complaint can be resolved based on the target merchant's dispute handling rules, then system 10 automatically resolves the complaint. Otherwise, complaint management system 10 automatically mediates resolution of the complaint between the consumer and the merchant. While mediation involves interacting with the consumer and the merchant, complaint management system 10 performs the interaction in a fully automated manner, that is, no human mediator is involved. If an agreement is reached, complaint management system 10 monitors compliance with the agreement. After compliance monitoring, or if no agreement was reached, the complaint is considered closed and complaint management system 10 automatically prepares an anonymized case summary. Throughout the operation phase, complaint management system 10 automatically updates the merchant's public record to reflect the current status of the case.

The anonymized case summaries and the merchant public records are available to any visitors to web site 12, irrespective of whether the visitors are registered members of system 10, to enable visitors to check on the dispute handling performance of merchants, and to obtain information about the disputes market.

### Setup

FIG. 2 is a flowchart depicting part of setup for system 10. Throughout the flowcharts, a box with double sidelines indicates a procedure call, that is, another flowchart. At step 110, consumer registration processing occurs. At step 120, merchant registration processing occurs.

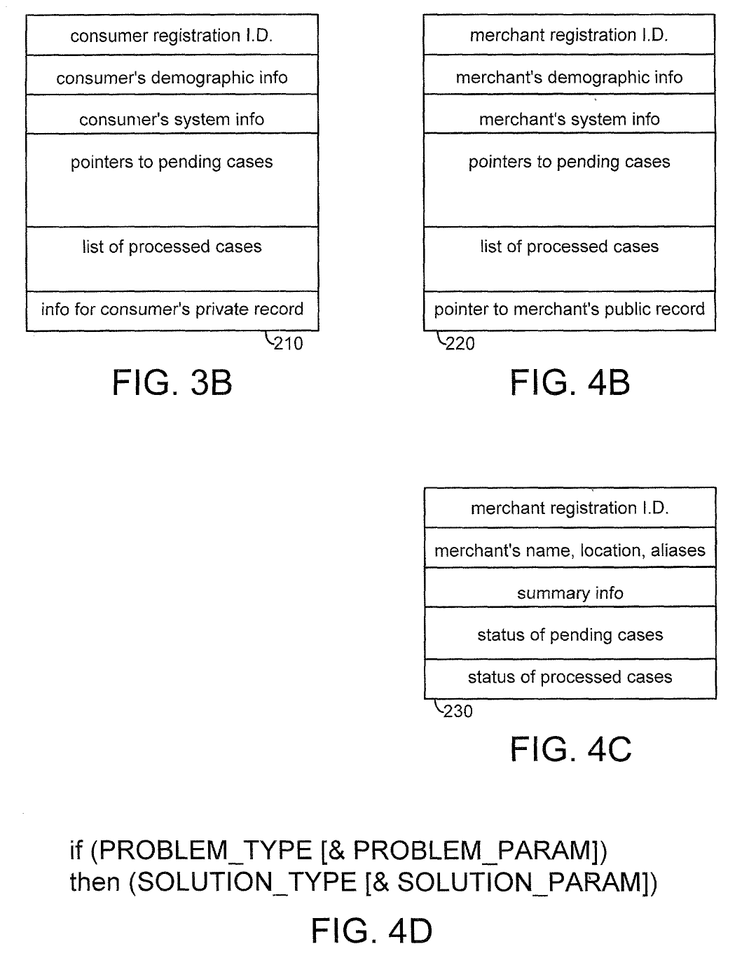

FIG. 3A is a flowchart depicting the consumer registration portion of the setup process of FIG. 2. At step 130, complaint management system 10 obtains demographic information from consumer 40. At step 140, consumer 40 provides its merchant-related information to complaint management system 10, such as the handle used by consumer 40 at merchant 20's web site (not shown).

FIG. 3B is a chart illustrating consumer registration record 210. Consumer registration record 210 is seen to include a consumer registration i.d. such as a unique alphanumeric designation generated by complaint management system 10, consumer demographic information discussed further below, consumer system information such as an access password, pointers to pending cases in case management system 14 such as unique case identifiers, a list of processed cases for this consumer such as unique case identifiers or pointers, and information for a consumer's private record including statistics about usage of complaint management system 10 automatically updated by complaint management system 10. It will be appreciated that consumer registration record 210 may be implemented as one physical record or as a series of logically coupled records or as fields in various records identifiable as relating to consumer 40 or in other manners apparent to those of ordinary skill in the art.

FIG. 4A is a flowchart depicting the merchant registration portion of the setup process of FIG. 2. At step 150, complaint management system 10 obtains demographic information from merchant 20. At step 160, complaint management system 10 validates merchant 20, that is, ensures that the party providing information is actually authorized to represent merchant 20. Validation can occur in various ways, including (i) a person places a telephone call to merchant 20 and confirms authority, (ii) a third party validation service provides authorization, or (iii) an organization that merchant 20 is affiliated with provides validating information, such as an access code known only to merchant 20.

At step 170, merchant 20 provides its business rules for dispute handling to system 10. Business rules are provided through one or more types of interfaces. Screen-based interfaces include: (i) providing all possible choices with checkoff buttons to indicate which are desired, (ii) a dynamic dialog that requests information from a merchant and builds a rule as the information is provided, and (iii) a set of static pages that form a guidance system for preparing a rule. Information is collected via text entry, radio buttons, pull down menus and the like. The rule is displayed in one or more of (a) internal system form, and (b) a more human-friendly form, in which phrases are substituted for variable names and data relationships are explicitly stated in words rather than by positioning or parentheses. Non-screen based interfaces include speech synthesis and voice response driven systems.

At step 180, merchant 20 optionally provides text paragraphs to system 10 for provision to consumers at various designated points in the dispute handling process, as shown in Table 1.

TABLE 1

| identifier | time provided |
|---|---|
| Merchant-Text-1 | when system 10 detects that consumer is trying to |
| | file a complaint against this merchant |
| Merchant-Text-2 | when the consumer has filed a complaint |
| Merchant-Text-3 | when an agreement has been automatically reached |
| | based on the merchant's business rules |
| Merchant-Text-4 | when the system has prepared the merchant's |
| | Answer for automated mediation based on the |
| | merchant's business rules |
| Merchant-Text-5 | when an agreement could not be reached in |
| | automated mediation |
| Merchant-Text-6 | when an agreement has been reached in automated |
| | mediation |
| Merchant-Text-7 | when both consumer and merchant have complied |
| | with the terms of an agreement |

FIG. 4B is a chart illustrating merchant registration record 220. Merchant registration record 220 is seen to include a merchant registration i.d. such as a unique alphanumeric designation generated by complaint management system 10, merchant demographic information discussed further below, merchant system information such as an access password, the merchant's business rules for dispute handling, and the merchant's text for provision during dispute handling, pointers to pending cases in case management system 14 such as unique case identifiers, a list of processed cases for this merchant such as unique case identifiers or pointers, and a pointer to merchant public record 230 shown in FIG. 4C. It will be appreciated that merchant registration record 220 may be implemented as one physical record or as a series of logically coupled records or as fields in various records identifiable as relating to merchant 20 or in other manners apparent to those of ordinary skill in the art.

FIG. 4C is a chart illustrating merchant public record 230. Merchant public record 230 is seen to include a merchant registration i.d. such as a unique alphanumeric designation generated by complaint management system 10 and merchant identification information recognizable to consumers such as “doing business as” names, web site identifiers and so on. Merchant public record 230 also includes summary information such as number of pending cases, number of processed cases, percent of cases in which an agreement was reached, and percent of cases in which compliance occurred given that an agreement was reached. Complaint management system 10 automatically updates the summary information in merchant public record 230. Merchant public record 230 also includes, for each pending case, its current status, and for each processed case, its status at the conclusion of processing by complaint management system 10. Since merchant public record 230 is strictly formatted and is updated only by complaint management system 10 in a predetermined manner, it is straightforward to compare the dispute handling performance of different merchants. In contrast, so called “feedback records” wherein people enter comments about merchants are difficult to aggregate as people use words differently, characterize the same behavior differently and so on.

FIG. 4D is a chart illustrating a business rule template. For a problem selected from a set of problem types, a merchant can specify at least one acceptable solution selected from a set of solution types. Each of the problem types and solution types can be modified with problem parameters and solution parameters, respectively. The problem parameters and solution parameters can be used in Boolean expressions; if the problem or solution parameters are of numeric type, then they can be used in computations, e.g., “if (today_date_purchase_date)<30) then . . . ” The problem parameters can relate to the item that is the subject of the complaint, such as “item order no.”, or to characteristics of the consumer, such as “member of merchant's preferred buyer club”, and so on.

The merchant must specify a precedence ordering for solutions. Accordingly, when a consumer happens to indicate that multiple solutions are acceptable to resolve his or her complaint, complaint management system 10 selects the “best” solution based on the merchant's predefined precedence ordering.

FIG. 4E is a flowchart depicting entering business rules for a merchant, more specifically, the interaction between merchant 20 and system 10 when merchant 20 provides its dispute handling rules to system 10.

At step 305, complaint management system 10 obtains the rules for any organization that the merchant is affiliated with, and displays these rules to the merchant. In one embodiment, the affiliated organization rules are referenced by linking, so that the affiliated organization rules may be updated from time to time in a manner transparent to all the merchants affiliated with the organization. In another embodiment, the affiliated organization rules are copied into the merchant's rules when the merchant's rules are entered.

At step 310, system 10 obtains the next problem type from the set of problem types, in this iteration, the first problem type. At step 315, system 10 obtains the next problem parameter from the set of problem parameters, in this iteration, the first problem parameter. At step 320, system 10 obtains a value, if any, for the problem type's problem parameter from merchant 20.

At step 330, system 10 obtains the next solution type from the set of solution types, in this iteration, the first solution type. At step 335, if the solution type is indicated by the merchant as being acceptable, system 10 makes a rule or updates an existing rule. At step 340, system 10 obtains the next solution parameter from the set of solution parameters, in this iteration, the first solution parameter. At step 345, if a value for the solution parameter is specified, system 10 updates the rule accordingly.

At step 350, complaint management system 10 checks if there are more solution parameters, and if so, returns to step 340. At step 355, complaint management system 10 checks if there are more solution types, and if so, returns to step 330.

At step 360, if more than one solution has been specified as being acceptable for this type of problem, with parameter values, if any, then system 10 obtains a precedence ordering for the acceptable solutions from merchant 20.

At step 365, complaint management system 10 shows the merchant the rule just built. If the rule is not as the merchant wished, then at step 370, the merchant edits the rule. When the rule is acceptable to the merchant, complaint management system 10 proceeds to step 375.

At step 375, complaint management system 10 checks if there are more problem parameters, and if so, returns to step 315. New rules will be built, if solutions are specified, and accepted as described above.

At step 380, complaint management system 10 checks if there are more problem types, and if so, returns to step 310. When all problem types have been checked, processing is complete.

### Operation

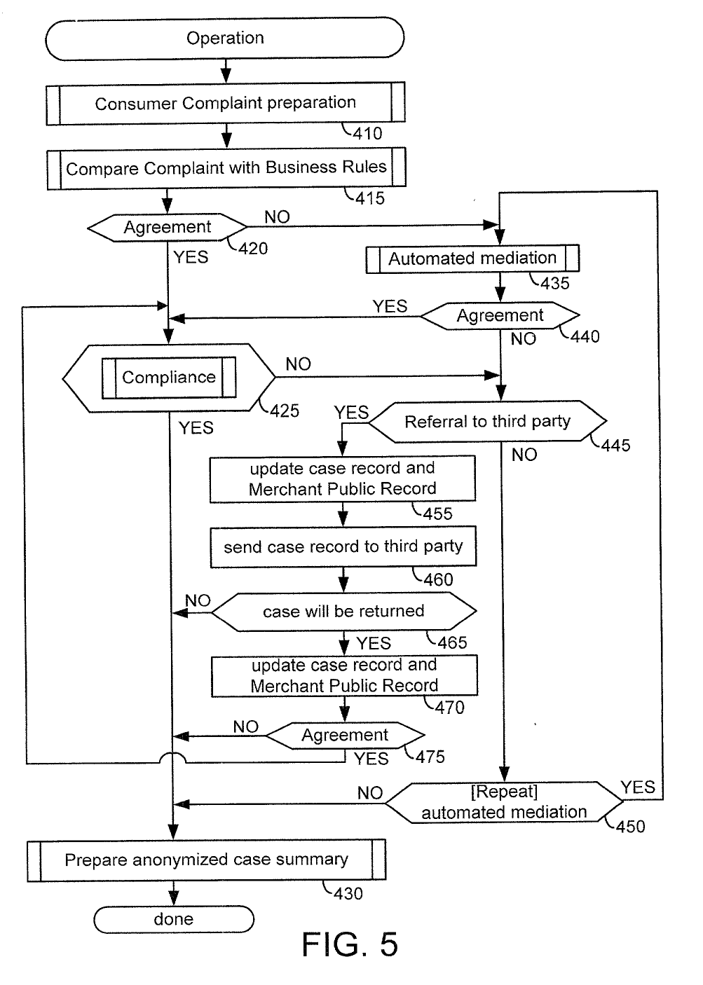

FIG. 5 is a flowchart depicting operation of system 10 in one embodiment.

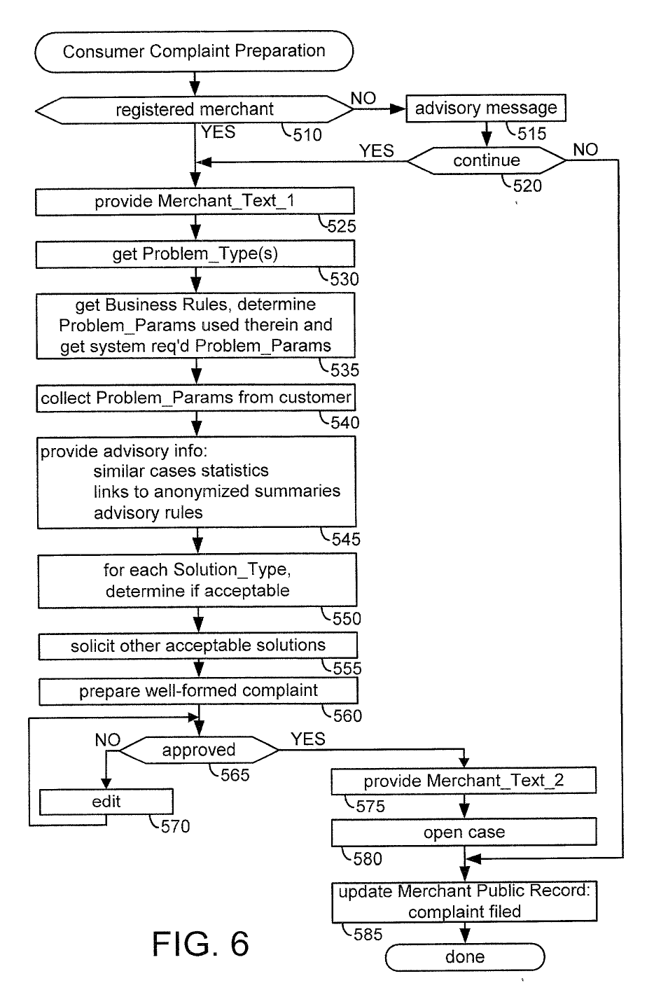

At step 410, consumer 40 prepares a complaint using complaint management system 10, as shown in FIG. 6.

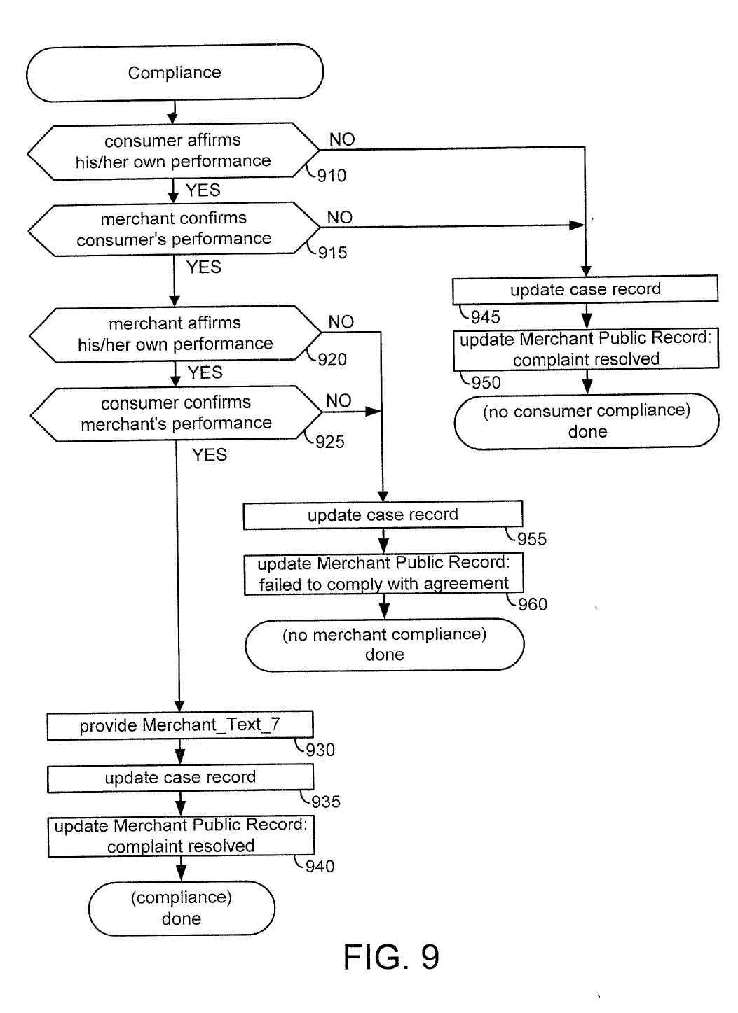

At step 415, complaint management system 10 compares the complaint from consumer 40 with the business rules for the merchant named in the complaint, herein assumed to be merchant 20 to detect whether merchant 20 will agree to the solutions desired by consumer 40. At step 420, complaint management system 10 determines whether there is an agreement. If so, then at step 425, complaint management system 10 monitors compliance with the agreement, as shown in FIG. 9.

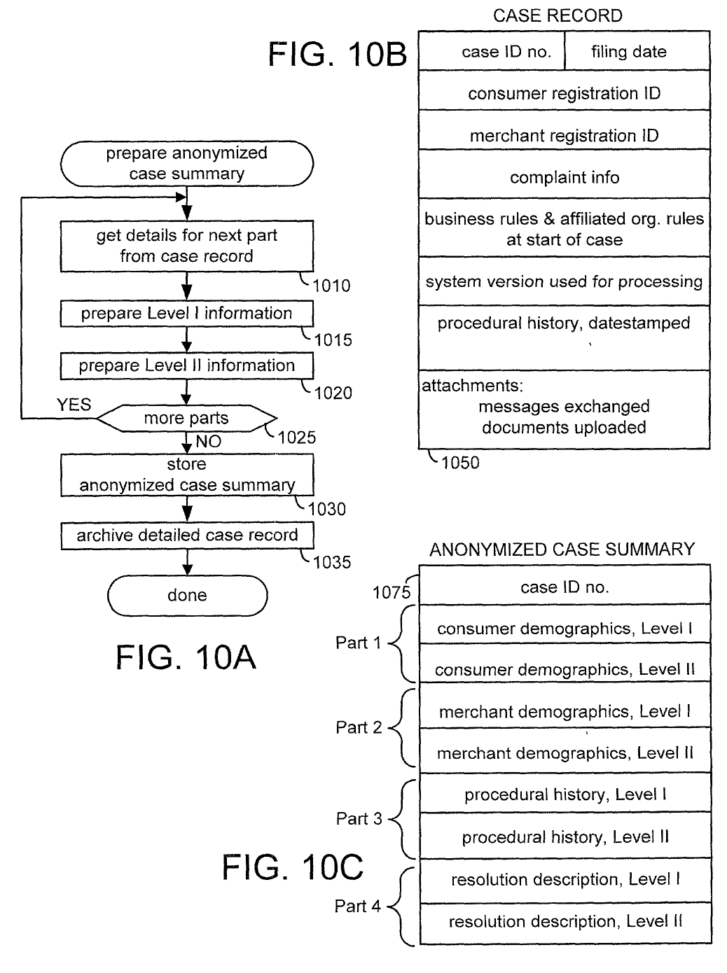

If merchant 20 and consumer 40 have performed according to their agreement, then at step 430, complaint management system 10 automatically prepares an anonymized case summary, as shown in FIG. 10A, and processing of the complaint is complete.

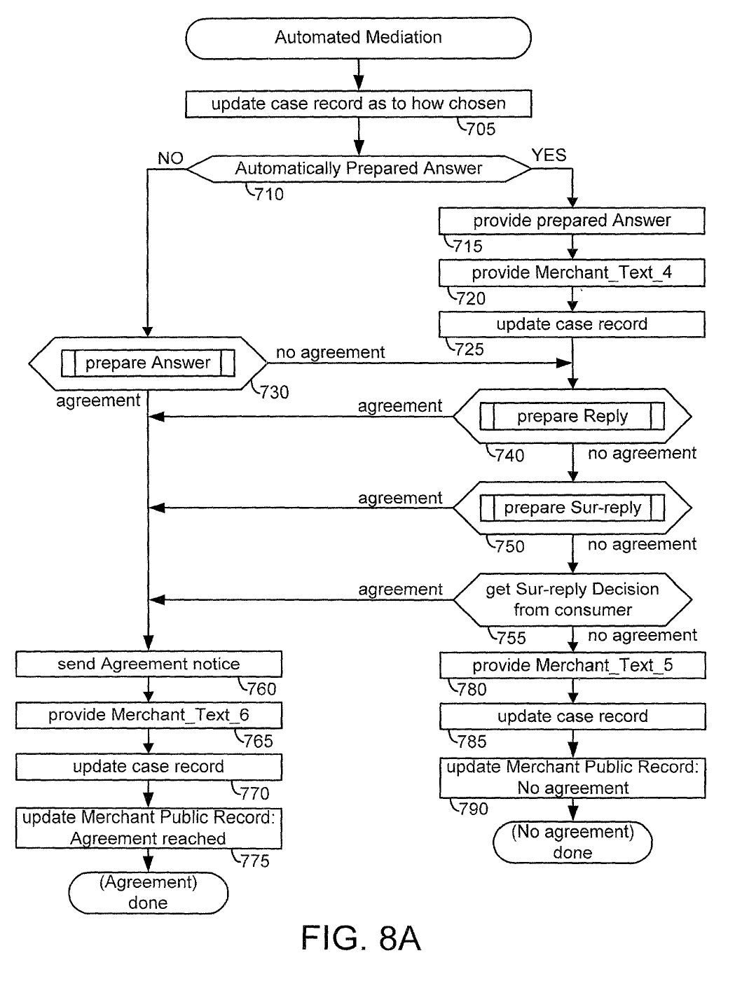

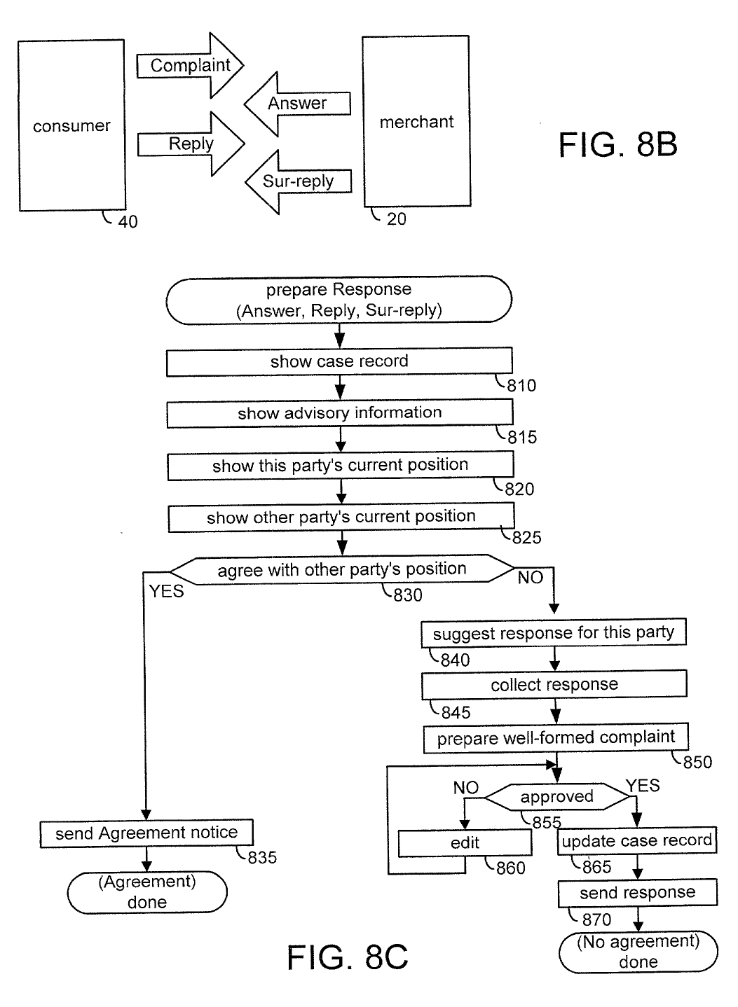

If an agreement was not detected by complaint management system 10 at step 420, then at step 435, complaint management system 10 performs automated mediation between merchant 20 and consumer 40, as shown in FIG. 8A. Consent to one round of automated mediation, as shown in FIG. 8A, is assumed due to registration of merchant 20 and consumer 40 with system 10. It will be appreciated that, if an agreement is not automatically reached based on the business rules, a complaint always is sent to automated mediation. At step 440, complaint management system 10 determines whether there is an agreement. If so, then processing proceeds to step 425 for compliance monitoring.

If an agreement has not been reached through automated mediation, then at step 445, complaint management system 10 determines whether the complaint should be referred to a third party.

One example of a third party is a human-directed dispute resolution service (system 10 is a computer-directed dispute resolution service) for mediation or arbitration; the complaint is referred to a human-directed dispute resolution service when both merchant 20 and consumer 40 consent to such referral and agree on how to pay the human-directed dispute resolution service. Typically, the human-directed dispute resolution service returns the complaint to complaint management system 10 after performing human-directed dispute resolution, which may or may not result in an agreement.

Another example of a third party is a computer-directed arbitration service (system 10 is a computer-directed mediation service). In particular, if consumer 40 used a credit card or debit card as his or her payment method, then merchant 20 typically must comply with automated dispute resolution procedures promulgated by the card provider. The complaint can be referred from complaint management system 10 to the payment arbitration service on the decision of consumer 40 alone, that is, consent by merchant 20 to the payment service's dispute resolution procedures is implied by acceptance of the payment card. The card provider usually is subject to an automated rules based arbitration system, with a procedure for appealing to a human arbitrator. The payment arbitration services typically do not return the complaint to complaint management system 10; other computer-directed arbitration services may return the complaint to complaint management system 10 after their processing thereof.

A farther example of a third party is a government regulator, such as the Federal Trade Commission (FTC), which has responsibility for policing consumer fraud. The complaint can be referred from complaint management system 10 to the government regulator on the decision of either merchant 20 or consumer 40 alone. The government regulator typically does not return the complaint to complaint management system 10 after its processing thereof.

Another example of a third party is a compensation fund that makes awards to consumers that are not properly cared for by merchants.

If the complaint is not to be referred to a third party, then at step 450, complaint management system 10 checks whether merchant 20 and consumer 40 wish to go through another round of automated mediation. If both merchant 20 and consumer 40 agree, then processing proceeds to step 435. If at least one of merchant 20 and consumer 40 does not wish to continue automated mediation, then processing proceeds to step 430 to prepare an anonymized case summary. Complaint management system 10 keeps track of how many rounds of automated mediation a complaint has experienced, and when the number of rounds reaches a predetermined threshold, complaint management system 10 generates an exception report for delivery to the administrator of complaint management system 10. The administrator may elect to intervene, such as by offering free human directed mediation to the parties. Alternatively, these multi-round cases may simply be flagged for subsequent study to better understand the dynamics of dispute resolution.

If the complaint is to be referred to a third party, then at step 455, complaint management system 10 updates the case record and the merchant public record as appropriate, and at step 460, sends the case record to the third party. At step 465, complaint management system 10 checks whether the case will be returned. If the case will not be returned, then processing proceeds to step 430 to prepare an anonymized case summary. If the case will be returned from the third party to complaint management system 10, then at step 470, complaint management system 10 waits for the return of the case and when the complaint is returned, updates the case record and the merchant public record, as appropriate, to reflect what occurred at the third party. At step 475, complaint management system 10 determines whether there is an agreement. If so, then processing proceeds to step 425 for compliance monitoring. If an agreement has not been reached, then processing proceeds to step 430 to prepare an anonymized case summary.

Complaint management system 10 typically communicates with merchant 20 and consumer 40 using a web site based interface, but also using e-mail. In some embodiments, web pages are dynamically created for presentation based on the status and details of the case. In some embodiments, complaint management system 10 leaves voice mail messages, send faxes or otherwise utilizes communication channels to transfer information between merchant 20 and consumer 40.

### Complaint Preparation

FIG. 6 is a flowchart depicting the consumer complaint preparation portion of the operation process of FIG. 5.

At step 510, complaint management system 10 checks whether the merchant that consumer 40 is trying to prepare a complaint against is a merchant registered with complaint management system 10. If the merchant is not registered with complaint management system 10, then at step 515, complaint management system 10 advises consumer 40 that the merchant is not registered, and so may not respond to the complaint. At step 520, complaint management system 10 checks whether the consumer wishes to continue. If consumer 40 elects to proceed with complaint preparation, processing proceeds to step 525 to continue with complaint preparation. Complaint management system 10 uses the prepared complaint as an incentive to encourage the merchant to register. Sales staff may also contact the merchant and try to get the merchant to register. If consumer 40 does not wish to continue with complaint preparation, then processing proceeds to step 585, and complaint management system 10 uses the complaint to prepare a public record for an unregistered merchant, so that web site visitors can evaluate unregistered merchants based on the prepared complaints.

At step 525, complaint management system 10 provides Merchant-Text-1 to consumer 40, such as, “XYZ Company apologizes for any problem you are having with your purchase. While you are welcome to use this system to file a complaint, we request that you go to our web site and click on the tab labeled Customer Service before filing a complaint with this system.” Another example of Merchant-Text-1 is, “WXY Company wants you to be happy with your purchase. We appreciate that you are taking the time to let us know how we can correct any problem you are having with a purchase from us. To thank you, we are giving you a coupon for 20% off your next purchase from us. Please enter coupon code DISPUTES123 when next ordering from us. We look forward to correcting the problem you are experiencing.”

At step 530, complaint management system 10 gets the problem type(s) from consumer 40. At step 535, complaint management system 10 obtains the set of rules in effect for merchant 20, including the business rules provided by merchant 20 and the rules of any organization that merchant 20 is affiliated with. In a modification, if the affiliated organization rules are already reflected in merchant 20's rules, then the affiliated organization rules are not obtained at step 535. Complaint management system 10 also obtains the system required problem parameters, that is, the minimal set of problem parameters that must be specified for each problem type. System 10 prepares anonymized case summaries, and may require certain information so that the anonymized case summaries are more meaningful for aggregate disputes market analyses. Based on the required problem parameters and the problem parameters relevant for merchant 20, complaint management system 10 identifies the set of information to collect from consumer 40. It will be seen that complaint management system 10 adapts its data collection based on the problem presented by consumer 40 and the disputes policy of merchant 20, thereby protecting consumer 40 against unnecessary data collection. At step 540, complaint management system 10 collects values for the identified problem parameters from consumer 40.

One of the system required parameters may be how the consumer feels about the problem. Collecting this information enables the consumer to vent their negative feelings, which is an important aspect of conflict resolution. Since complaint management system 10 is a computer, that is, not human, consumers are encouraged to “let it all out” without fear of hurting someone's feelings. In one embodiment, complaint management system 10 reflects back the consumer's emotional situation, such as by selecting, based on lexical and syntactical analysis, one or more of a set of predefined emotional states and asking the consumer to confirm that its selection is correct. Certain problem types may be associated with default emotional states, e.g., “disappointed, annoyed and frustrated.” This emotional reflection comprises anonymizing the emotional response of the consumer (anonymizing is discussed below), with Level I being selecting predetermined emotional states, and Level II being adding the specific words used by consumer 40.

The feeling related information collected from consumer 40 is referred to as emotional detail information. The reflection of the consumer's feelings generated by complaint management system 10 is referred to as emotional state information. An example of emotional detail information and corresponding emotional state information is provided in the use cases, below.

Some parameters may enable consumer 40 to upload a file from their personal computer. For example, consumer 40 may wish to provide a copy of their e-mail receipt as an attachment to their complaint, or another computer file, such as an explanatory letter, or a scanned image file. In one embodiment, complaint management system 10 automatically creates descriptive information for the attached file, such as, “image of item as received from shipper”; in another embodiment, consumer 40 provides a short textual description of what is in the attached file.

At step 545, complaint management system 10 provides advisory information to consumer 40. In one embodiment, complaint management system 10 uses the complaint characteristics to search for anonymized case summaries having similar characteristics, and then creates a custom summary of the case resolutions in the similar cases, for example, a pie chart showing the top five resolution types and their percentage, and presents this information to consumer 40. In a modification, complaint management system 10 provides access to the five most recent anonymized case summaries having similar characteristics, in addition to or instead of the custom summary. In another embodiment, complaint management system 10 has a set of advisory rules, and based on the characteristics of the complaint, determines how the complaint would be resolved under the advisory rules. For example, the credit card association chargeback rules could be the set of advisory rules, and be consulted independent of the payment form used in the problem. In another embodiment, system 10 simply encourages consumer 40 to browse the anonymized case summaries. In some cases, system 10 may provide general information such as, “complaints identifying at least two acceptable solutions are 73% more likely to be immediately resolved than complaints identifying only one acceptable solution,” or whatever the actual statistic is.

Providing advisory information, also referred to as relevant contextual information, helps set expectations for consumer 40. Specifically, when the advisory information is relevant to consumer 40's specific problem, consumer 40 is more likely to consider such information. The process of providing advisory information frames the issue to consumer 40 as participating in an infrastructure for problem solving, rather than having an isolated problem.

At step 550, complaint management system 10 obtains desired types of solutions from consumer 40. At step 555, system 10 may ask consumer 40 to approve other solutions, such as the most popular solution for the consumer's type of problem, merchant 20's preferred solution for this type of problem, and so on.

At step 560, complaint management system 10 uses the information provided by consumer 40 to prepare a well-formed complaint, that is, a complaint having information pertinent to the problem that the consumer can provide and which is needed for problem resolution, the information being organized and presented so it is readily understood by a human. If emotional information was provided, system 10 provides its reflection of the emotional information, so that the well-formed complaint is more polite and professional.

As used herein and in the claims, a well-formed message includes identification of the case, date of the message, type of the message—e.g., Complaint, Answer, Reply or Sur-reply- and substantive information for the message. When the message is a response to another message, i.e., not a complaint, the message also includes the next action and a date by which the next action must be taken.

At step 565, complaint management system 10 asks consumer 40 to approve filing of the well-formed complaint. If consumer 40 wishes to modify the complaint, at step 570, complaint management system 10 enables consumer 40 to edit the complaint. When the consumer is satisfied with the well-formed complaint and approves its filing, processing proceeds to step 575.

At step 575, complaint management system 10 provides Merchant-Text-2, if any, to consumer 40. At step 580, complaint management system 10 opens a case for this complaint. Complaint management system 10 creates a case record comprising the registration identifiers for consumer 40 and merchant 20, the rules in effect at the start of the case, the information provided by consumer 40, and the well-formed complaint approved by consumer 40. Associating the rules in effect at the start of the case with the case record facilitates subsequent analysis of the dynamics of dispute resolution; specifically, “what if” scenarios are easier to analyze because the entire rule set is available.

At step 585, complaint management system 10 updates public record 230 for merchant 20 to indicate that a new complaint has been filed, and complaint preparation processing is complete.

### Automated Agreement

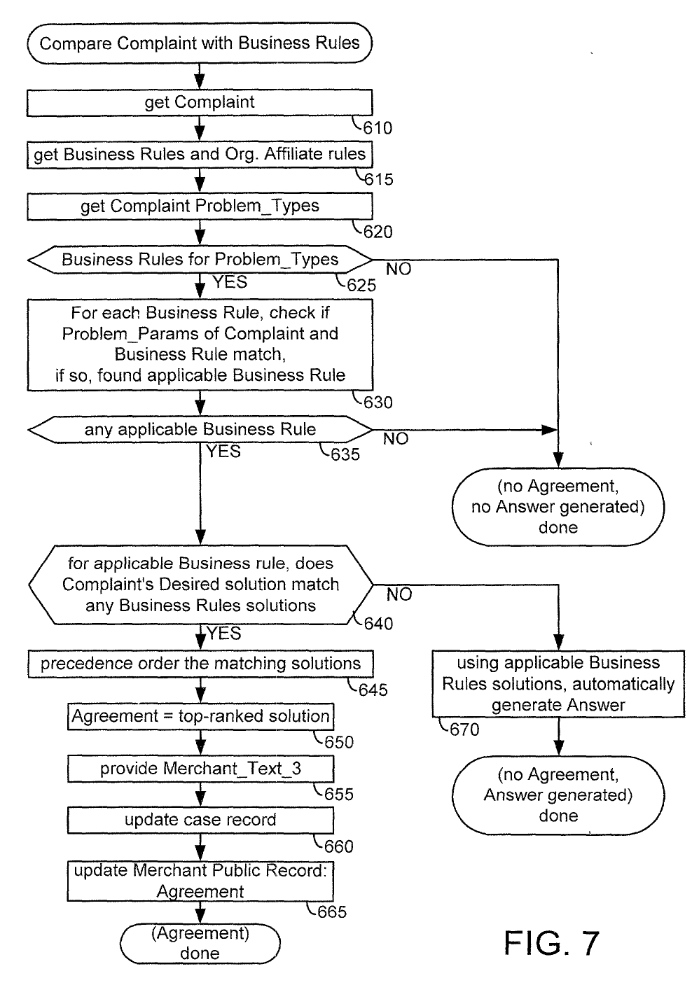

FIG. 7 is a flowchart depicting the comparing of a complaint with a merchant's business rules portion of the operation process of FIG. 5.

At step 610, complaint management system 10 gets the case record and obtains the complaint information. At step 615, complaint management system 10 gets the business and organizational rules from the case record, hereafter referred to as “business rules” for brevity. At step 620, complaint management system 10 obtains the complaint problem type(s). At step 625, complaint management system 10 checks whether there are business rules applicable to the problem type(s) in the complaint. If there are no applicable business rules, then automated agreement processing terminates, and the case proceeds to automated mediation.

If there are business rules applicable to the complaint's problem type(s), then at step 630, complaint management system 10 determines whether the values provided by consumer 40 for the problem parameters, at step 540 of FIG. 6, are consistent with the business rule being applicable to the consumer's problem. At step 635, checks whether there are any business rules that apply to this complaint. If there are no applicable business rules, then automated agreement processing terminates, and the case proceeds to automated mediation.

If there are applicable business rules, then at step 640, complaint management system 10 checks whether any of the desired solutions in the complaint match the solutions specified in the business rules. If none of the desired solutions in the complaint match the solutions specified in the business rules, then at step 670, complaint management system 10 identifies the solutions in the applicable business rules as merchant 20's counter-offer to consumer 40's desired solutions. Complaint management system 10 automatically prepares an Answer to the complaint incorporating the identified solutions, and the case proceeds to automated mediation with the merchant's Answer automatically generated by complaint management system 10. Automatically preparing an Answer is also referred to as generating a complaint resolution offer on behalf of the party based on the acceptable solutions specified in the rules of the party.

If any of the desired solutions in the complaint match the solutions specified in the business rules, then at step 645, system 10 precedence orders the matching solutions, and at step 650, defines the top-ranked solution as being an agreement between merchant 20 and consumer 40 and notifies consumer 40 of an agreement. It will be appreciated that the agreement has been immediately determined in response to the complaint.

At step 655, complaint management system 10 provides Merchant-Text-3, if any, to consumer 40. For example, Merchant-Text-3 may be product return instructions for consumer 40, including an estimate of when the consumer will receive a refund. In one embodiment, Merchant-Text-3 has different versions depending on the type of solution in the agreement. At step 660, complaint management system 10 updates the case record to reflect that an agreement was automatically determined, and appends the notices provided to consumer 40. At step 665, complaint management system 10 updates merchant public record 230 to reflect that an agreement was reached in this case, and automated agreement processing is complete.

### Automated Mediation

FIG. 8A is a flowchart depicting the automated mediation portion of the operation process of FIG. 5.

FIG. 8B shows a round of automated mediation as comprising the Complaint from consumer 40 against merchant 20, followed by an Answer from merchant 20 to consumer 40, followed by a Reply from consumer 40 to merchant 20, and concluding with a Sur-reply from merchant 20 to consumer 40. An agreement can occur upon receiving the Complaint, Answer, Reply or Sur-reply. An agreement requires the consent of both merchant 20 and consumer 40. In some disputes, an agreement does not occur.

At step 705 of FIG. 8A, complaint management system 10 updates the case record to indicate why automated mediation is occurring, generally, because a complaint could not be initially resolved based on automated rules, or because the parties have agreed to another round of automated mediation. If necessary, complaint management system 10 updates merchant public record 230 to indicate that the case is pending.

At step 710, complaint management system 10 checks if there is an automatically prepared Answer. If there is an automatically prepared Answer, from step 670 of FIG. 7, then at step 715, complaint management system 10 provides the Answer to consumer 40. At step 720, complaint management system 10 provides Merchant-Text-4, if any, to consumer 40, and at step 725, complaint management system 10 updates the case record to reflect provision of the Answer and Merchant-Text-4. The automatically prepared Answer and Merchant-Text-4 are usually presented to consumer 40 while he or she is still at web site 12, after filing the Complaint. In some embodiments, the automatically prepared Answer and Merchant-Text-4 are delivered to consumer 40 via e-mail.

If no automatically prepared Answer exists, then at step 730, complaint management system 10 assists merchant 20 in preparing an Answer according to the logic shown in FIG. 8C.

After preparation of an Answer, if an agreement does not exist, then at step 740, complaint management system 10 assists consumer 40 in preparing a Reply according to the logic shown in FIG. 8C.

After preparation of a Reply, if an agreement does not exist, then at step 750, complaint management system 10 assists merchant 20 in preparing a Sur-reply according to the logic shown in FIG. 8C.

At step 755, complaint management system 10 checks whether consumer 40 has accepted one of the solutions proposed in merchant 20's Sur-reply.

If no agreement exists after the Sur-reply, then at step 780, complaint management system 10 provides Merchant-Text-5, if any, to consumer 40. At step 785, complaint management system 10 updates the case record to reflect lack of an agreement. At step 790, complaint management system 10 updates merchant public record 230 to show that no agreement was reached, and automated mediation is complete.

If an agreement was detected at steps 730, 740, 750 or 755, then at step 760, complaint management system 10 sends a notice of the agreement to consumer 40 and merchant 20. At step 765, complaint management system 10 provides Merchant-Text-6, if any, to consumer 40, and at step 770, complaint management system 10 updates the case record to reflect the agreement. At step 775, complaint management system 10 updates merchant public record 230 to show that an agreement was reached, and automated mediation processing is complete.

If merchant 20 does not respond within the allotted time for response, then the case is closed and the merchant's public record is updated to show that the merchant was non-responsive to a complaint.

If consumer 40 does not respond within the allotted time for response, then consumer 40 is presumed to have abandoned the case, the case is closed and the merchant's public record is updated to show that that the case was successfully resolved.

FIG. 8C is a flowchart depicting preparation of a response in automated mediation. A response is any one of an Answer, a Reply or a Sur-reply. The party preparing the response is merchant 20, in the case of an Answer or Sur-reply, and is consumer 40, in the case of a Reply.

At step 810, complaint management system 10 shows the case record to the party preparing the response, such as by appending the case record to an e-mail or providing a hyperlink to a password-protected web page showing the case record. At step 815, complaint management system 10 may show advisory information to the party preparing the response, such as a pie chart indicating the most popular resolutions of similar disputes. At step 820, complaint management system 10 shows this party's current position, that is, the solutions indicated as acceptable to this party. Where an Answer is being prepared, there may be no solutions indicated as acceptable based on merchant 20's business rules. At step 825, complaint management system 10 shows the contra-party's current position, that is, the solutions acceptable to the contra-party.

At step 830, complaint management system 10 determines whether the party preparing the response agrees with any of the contra-party's acceptable solutions. If so, then an agreement has been reached and at step 835, complaint management system 10 sends an agreement notice to consumer 40 and merchant 20.

If the party preparing the response does not agree to any of the contra-party's acceptable solutions, then at step 840, complaint management system 10 may suggest a response for this party. In particular, in some cases, complaint management system 10 can determine that the parties are in agreement except for certain factors, and suggests a response focused on the factors blocking agreement.

For example, assume that a Sur-reply is being prepared, and that the complaint indicated a refund was acceptable, an automatically prepared Answer offered a refund subject to a re-stocking fee and with no return shipping, and the Reply indicated that a refund was acceptable with a re-stocking fee as long as return shipping was paid by the merchant. Here, the parties agree about a refund with restocking fee, and disagree only about the return shipping fee. Accordingly, system 10 may suggest a Sur-Reply of refund with restocking fee and a personalized handling of the return shipping cost, meaning that merchant 20 should carefully decide how to handle the return shipping feature.

At step 845, complaint management system 10 obtains the response from the party preparing the response. In some cases, the party preparing the response may simply agree to system 10's suggestion, such as by sending an e-mail to complaint management system 10 with “yes” in the subject line. In other cases, the party preparing the response may interact with pages supplied by web site 12 to provide the response. In some embodiments, such as when the response is a Reply, response preparation includes asking the preparer how he or she feels about the other party's position and/or their own position, such as why it is fair, collecting the response as emotional detail information, and reflecting back their emotional state as emotional state information. Such interaction provides a feeling of “being heard.”

At step 850, complaint management system 10 prepares a well-formed response based on the information collected at step 845. A well-formed response is a standalone communication stating what the complaint was, the acceptable solutions from the party sending the response, and the options available to the party receiving the response. Usually the options available to the party receiving the response are either to agree to one of the sender's acceptable solutions or to prepare their own response.

At step 855, complaint management system 10 checks whether the party preparing the response has approved filing the well-formed response. If not, then at step 860, the party preparing the response edits the well-formed response, and at step 855, complaint management system 10 presents the edited well-formed response for filing approval.

After the party preparing the response approves the well-formed response, at step 865, complaint management system 10 updates the case record and at step 870, sends the well-formed response to the contra-party. The response is usually sent via e-mail. In some embodiments, other communications methods are used, such as voice mail. No agreement has been reached.

### Compliance Monitoring

FIG. 9 is a flowchart depicting the compliance portion of the operation process of FIG. 5. In the embodiment shown in FIG. 9, each of consumer 40 and merchant 20 affirms their own performance and confirms the contra-party's performance. In other embodiments, the affirmance and/or confirmance are performed automatically using an external source, such as third party shipping services or automatic payment services. When an external source is involved, complaint management system 10 receives notice from the external source when an event occurs. In a modification, complaint management system 10 queries the external source to determine if the event has occurred, and the external source sends notice in response to the query from complaint management system 10.

At step 910, complaint management system 10 checks whether consumer 40 affirmed that they performed according to the agreement, for example, that consumer 40 returned defective merchandise by a particular date. Consumer 40 affirms their performance by sending an e-mail to system 10, providing information to a web page at web site 12 or the like. At step 915, complaint management system 10 checks whether merchant 20 confirmed that consumer 40 performed his or her portion of the agreement. Merchant 20 provides confirmation using e-mail, a web page or other appropriate mechanism.

If consumer 40 did not affirm their performance, or merchant 20 did not confirm consumer 40's performance, then complaint management system 10 gives merchant 20 the benefit of the doubt, and considers the complaint to be resolved. At step 945, complaint management system 10 updates the case record to reflect non-performance by the consumer, and at step 950, complaint management system 10 updates merchant public record 230 to show that the complaint was resolved. Although not shown in FIG. 9, if merchant 20 affirmatively denies performance that consumer 40 has affirmed, there is a procedure whereby consumer 40 can prove their performance.

At step 920, complaint management system 10 checks whether merchant 20 affirmed that they performed according to the agreement, for example, that merchant 20 sent a refund check to consumer 40 by a particular date. Merchant 20 provides affirmation in similar manner as consumer 40, discussed above. At step 925, complaint management system 10 checks whether consumer 40 confirmed that merchant 20 performed its portion of the agreement. Consumer 40 provides confirmation in similar manner as merchant 20, discussed above.

If merchant 20 did not affirm their performance, or consumer 40 did not confirm merchant 20's performance, then at step 955, complaint management system 10 updates the case record to reflect non-performance by the merchant, and at step 960, complaint management system 10 updates merchant public record 230 to show that merchant 20 failed to comply with its agreement. Although not shown in FIG. 9, if consumer 40 affirmatively denies performance that merchant 20 has affirmed, there is a procedure whereby merchant 20 can prove its performance.

When both parties have affirmed their performance and confirmed the contra-party's performance, at step 930, complaint management system 10 provides Merchant-Text-7, if any, to consumer 40. At step 935, complaint management system 10 updates the case record, including closing the case. At step 940, complaint management system 10 updates merchant public record 230 to show that the complaint was successfully resolved, and compliance monitoring processing is complete.

It will be appreciated that confirmation of an action can occur by either providing a positive indication, or by failing to provide a negative indication by a particular date.

### Anonymized Case Summary

FIG. 10A is a flowchart depicting the preparing an anonymized case summary portion of the operation process of FIG. 5. An anonymized case summary is prepared when complaint management system 10 has finished processing a case, to include the activity that occurred during the case as a contribution to a database of disputes while preserving the privacy of the parties to the dispute. At present, the private (non-judicial) dispute resolution market is ill understood as information relating to privately resolved disputes is usually private.

An anonymized dispute can have multiple levels of information granularity. As an example, two levels are explained herein. Level I shows information about the case but only as ranges. Level II shows more specific detail about the case, but still sufficiently broad to not readily identify a party.

An anonymized case summary is prepared by taking the detailed case record, extracting relevant information and then selecting categories for Level I parameters and values for Level II parameters in accordance with the relevant information. The information is organized into parts; in this example, Part 1 of an anonymized case summary is consumer demographic information, Part 2 is merchant demographic information, Part 3 is the procedural history of the case including the complaint description, and Part 4 is the resolution description. A case identifier enables the anonymized case summary to be associated with the detailed case record, should further analysis be required. The privacy of detailed case records is strictly maintained.

FIG. 10B is a chart depicting detailed case record 1050, and FIG. 10C is a chart depicting anonymized case summary 1075. Case record 1050 is coupled to all documents uploaded from a consumer or a merchant during processing of the case, including text files, image files, and so on. In some embodiments, faxes, if any, are scanned at complaint management system 10 to become image files that are attached to case record 1050.

At step 1010 of FIG. 10A, complaint management system 10 gets case record 1050 and extracts details for the next part, in this iteration, Part 1. At step 1015, complaint management system 10 prepares Level I information for anonymized case summary 1075. At step 1020, complaint management system 10 prepares Level II information for anonymized case summary 1075. At step 1025, complaint management system 10 checks whether there are more parts of anonymized case summary 1075 to prepare. If so, processing returns to step 1010.

When all parts of anonymized case summary 1075 have been prepared, at step 1030, complaint management system 10 stores anonymized case summary 1075 in database 18. At step 1035, complaint management system 10 archives case record 1050, and anonymized case summary processing is complete.

### Use cases

### Use cases: Business Rules Entry

Let it be assumed that merchant 20 delivers a product to consumer 40. Some products are delivered via a shipper, such as clothing or other goods, while other products are delivered via the Internet, such as documents or image files.

Table 2 shows the predefined problem types in complaint management system 10, with associated optional problem parameters and the values acceptable for the problem parameters. The “parameter-value” column indicates the nature of the parameter, e.g., textual (TEXT) or numeric (NN), or specific values that may be assumed by the parameter, e.g., “too big” or “too small.” At the end of Table 2 are optional problem parameters, “&Product” and “&Feeling”, that are actually more akin to descriptions of the problem; these are presented to consumer 40 as questions to answer while describing the problem type.

TABLE 2

| Problem-type | Problem-parameter | Parameter-value |
|---|---|---|
| Not as expected | Size | too big, too small |
| | Color | too dark, too light, |
| | | didn't match |
| | Version | |
| | Poor quality | materials, workmanship |
| | Text description | TEXT |
| Defective | Damaged upon arrival | |
| | Would not operate | |
| | properly | |
| | Would not assemble | |
| | properly | |
| | Problem developed | |
| | during use | |
| | Text description | TEXT |
| Delivery | Arrived too late | NN days later than |
| | | expected |
| | Did not arrive | |
| | Downloading problem | |
| | Text description | TEXT |
| Companion product | Problem with companion | |
| | Text description | TEXT |
| Billing problem | Billed for item that didn't | |
| | arrive | |
| | Billed twice for same | |
| | item | |
| | Billed for unauthorized | |
| | add-on | |
| | Discount or coupon not | |
| | applied | |
| | Refund promised but | |
| | didn't arrive | |
| | Text description | TEXT |
| Unwanted gift | Text description | TEXT |
| Other | Text description | TEXT |
| &Product-info | Item cost | NN |
| | Delivery cost | NN |
| | Tax cost | NN |
| | Other cost | NN |
| | Purchase date | DATE |
| | Scheduled delivery date | DATE |
| | Actual delivery date | DATE |
| | Item sold-as status | new, irreg., used, as-is |
| | Item sales price status | regular, sale |
| | Item order no. | NN |
| | Item SKU no. | NN |
| | Item description | TEXT |
| | Item quantity | NN |
| | Item sales channel | store, mail order, internet |
| &Feeling-problem | summary | confident-of-resolution, |
| | | frustrated, disappointed, |
| | | embarrassed |
| | Text description | TEXT |

The term SKU is an acronym for stock-keeping unit.

Table 3 shows the predefined solution types in complaint management system 10, with associated optional'solution parameters and the values acceptable for the solution parameters. A business rule cannot specify “other” as a solution; the “other” solution type can be specified only by a consumer during complaint preparation. If the customer's only desired solution is “other”, then none of the business rules will provide a matching solution and the case will go to automated mediation. At the end of Table 3 are optional solution parameters, “&Bonus” and “&Feeling” that enhance information flow between consumer 40 and merchant 20.

TABLE 3

| Solution-Type | Solution-parameter | Parameter-value |
|---|---|---|
| Refund | payment method | original, different |
| | shipping to consumer | will refund, won't refund |
| | return shipping from | will refund, won't refund |
| | consumer | |
| | text message | TEXT |
| Store credit | text message | TEXT |
| Exchange for | return shipping from | will refund, won't refund |
| another item | consumer | |
| | discount on additional | NN% |
| | purchases | |
| | text message | TEXT |
| Repair | describe desired repair | TEXT |
| | text message | TEXT |
| Other | describe | TEXT |
| | text message | TEXT |
| &Bonus | coupon for n% off next | NN |
| | purchase | |
| | free gift as apology | |
| | text message | TEXT |
| &Feeling-Solution | summary | |
| | text description | TEXT |
| | text message | TEXT |

Let merchants 21 and 22 be coupled to complaint management system 10 in similar manner as merchant 20. Let the automated complaints policies for merchants 20-22 be as shown in Table 4. Merchants may adopt any policy or exceptions they wish during automated mediation. Table 4 also shows the rules required by complaint management system 10, considered as an affiliated organization.

TABLE 4

| | Merchant complaints policy |
|---|---|
| Merchant 20 | Exchange within 30 days of purchase for another |
| | item or store credit for up to one year. If defective, |
| | will provide refund, credit or exchange but not |
| | repair. |
| Merchant 21 | Will refund or exchange or provide store credit if |
| | the item cost was under $100 or the item was |
| | purchased within the last 30 days, and will not pay |
| | for return shipping. Otherwise, will exchange or |
| | provide store credit. If defective, will exchange and |
| | will pay for return shipping. |
| Merchant 22 | Do whatever the customer wants, will pay for the |
| | customer's shipping and return shipping. If customer |
| | exchanges for item of higher value, give 10% dis- |
| | count on higher valued item. If defective, do what- |
| | ever the customer wants and provide free gift. |
| Complaint | Must collect item description, item quantity, item |
| management system | value, purchase date, item sales channel, how |
| 10 | customer feels about problem with text description, |
| | how customer feels about their desired solutions |
| | with text description. |

Table 5 shows the rule sets generated after each of merchants 20-22 has entered rules according to the procedure shown in FIG. 4E.

TABLE 5

| | Automated complaints policy |
|---|---|
| Merchant 20 | 1. If ( (not-as-expec or delivery or companion) |

& ((today-date − purchase-date) ≦ 30)

)

then ( (exchange & (return-shipping = won't

refund))

or (credit & (text-message = “Good for one

year”)

& (return-shipping = won't

refund))

)

2. If (defective)
then ((refund or credit or exchange) & (return-

shipping = will refund)

)

| | |
|---|---|
| | PREC: exchange > credit > refund > repair |
| Merchant 21 | 1. If ((not-as-expec or delivery or companion) |

& ( ((today-date − purchase-date) ≦ 30)

or (item-cost ≦ 100)

)

)

then ((refund or credit or exchange) & (return-

shipping = won't refund)
)

2. If (not-as-expec or delivery or companion)
then ((credit or exchange) & (return-

shipping = won't refund)
)

3. If (defective) then (exchange & (return-

shipping = will refund)

| | |
|---|---|
| | PREC: refund > credit > exchange > repair |
| Merchant 22 | 1. If (*) |
| | then ((refund |

or credit
or (exchange & bonus = “10% off higher value

exchange item”)

or repair)
& (shipping-to-consumer = will refund)
& (return-shipping = will refund)

)

2. If (defective)
then ( (refund or credit or exchange or repair)

& (shipping-to-consumer = will refund)
& (return-shipping = will refund)
& (bonus = free gift)

)

| | |
|---|---|
| | PREC: exchange > refund > repair > credit |
| Complaint | 1. If (item-cost & purchase-date & sales-channel & |
| management system | feeling-problem) then (feeling-solution) |
| 10 | |

Complaint management system 10 may offer merchants predefined complaints policy sets, such as those shown in Table 5, which can be modified by the merchant. When a merchant chooses a predefined complaints policy set with no modifications, the merchant need not go through the detailed rules entry procedure shown in FIG. 4E.

### Use cases: Consumer Complaint Preparation

Let consumers 41 and 42 be coupled to complaint management system 10 in similar manner as consumer 40. Assume that the consumers' complaints are as shown in Table 6

TABLE 6

| | Consumer complaints |
|---|---|
| Consumer 40 | Bought two lamps for $400 each two weeks ago, and wants |
| | a refund |
| Consumer 41 | Bought a sweater for $90 20 days ago, wants to exchange it |
| | for a different size and color |
| Consumer 42 | Bought a custom astrology report for $20, but it wasn't as |
| | in-depth as expected, so wants refund. |

During preparation of a well-formed complaint for each consumer, complaint management system 10 collects all information needed to determine whether the automated rules for a merchant apply, including all problem-parameters in a merchant's business rules, and all information required by an affiliated organization, including the information required by complaint management system 10.

One type of information required by complaint management system 10 is how the customer feels about the problem. In one embodiment, complaint management system 10 presents a menu of feeling adjectives, such as: “happy, hopeful, confident, confused, disappointed, frustrated, angry,” to the consumer, and the consumer selects at least one feeling from the menu. Additionally, complaint management system 10 presents a free form text entry area to the consumer, and requests that the consumer provide more detail on their feelings. Complaint management system 10 uses lexical and syntactical analysis of the consumer's detailed feeling information to select one or more feeling summary statements, and then presents the summary statements to the consumer as a reflection of their feelings. The consumer either approves the summary or modifies it and then approves the modified summary. Modification can be directly, such as by editing the summary, or indirectly, such as by providing more feeling explanation that is used by complaint management system 10 to customize the words in the summary.

For example, assume consumer 42 selects “disappointed” and provides the following emotional detail information:

“This was a lousy report. I thought it would give daily forecasts and all I got was mumbo jumbo. I was gypped!”

Complaint management system 10 uses the emotional detail information to generate the following emotional state information:

“You feel the report is poor quality. Is this right?”

More specifically, complaint management system 10 compares the item description, an astrology report, with the detail text to identify “ITEM=report” in the detail text. Complaint management system 10 extracts “lousy” as an ADJECTIVE for ITEM, then uses its dictionary to find “poor quality” as a synonym. Finally, complaint management system 10 selects the summary template, “You felt the ITEM was ADJECTIVE”, and inserts the specific values for the item and synonym. Conventional e-mail processing systems use various lexical and syntactical analysis techniques to “understand” natural language. Consumer 42 then indicates their approval of the generated emotional state.

When complaint management system 10 detects that the consumer has indicated only one type of solution is acceptable, complaint management system 10 prompts the consumer to select at least two types of solutions to improve the chances of resolving this complaint. In some embodiments, complaint management system 10 uses the applicable business rules to suggest which type(s) of solutions should be selected by the consumer. In alternative dispute resolution terminology, such interaction is referred to as “assisted negotiation.”

After automated complaint preparation the well-formed complaints are as shown in Table 7.

TABLE 7

| | Well-formed complaints | |
|---|---|---|
| Consumer 40 | consumer ID | 40 |
| | merchant ID | 20 |
| | complaint filing date | 02/22/01 |
| | problem-type | not as expected |
| | item description | walnut/chrome floor lamps |
| | item quantity | 2 |
| | item-cost | $800 |
| | purchase-date | 02/15/01 |
| | sales-channel | store |
| | feeling-problem | frustrated, wants to be treated fairly |
| | solution-type | refund |
| | feeling-solution | entitled, store clerk promised refund |
| Consumer 41 | consumer ID | 41 |
| | merchant ID | 21 |
| | complaint filing date | 02/22/01 |
| | problem-type | not-as-expected |
| | item description | Peruvian pullover sweater |
| | item quantity | 1 |
| | item-cost | $90 |
| | purchase-date | 02/02/01 |
| | sales-channel | mail order |
| | feeling-problem | disappointed, loves item but wants |
| | | proper fit |
| | solution-type | exchange or refund |
| | feeling-solution | hopeful, see above |
| Consumer 42 | consumer ID | 42 |
| | merchant ID | 22 |
| | complaint filing date | 02/22/01 |
| | problem-type | defective |
| | item description | 3 month astrology report |
| | item quantity | 1 |
| | item-cost | $20 |
| | purchase-date | 02/22/01 |
| | sales-channel | Internet |
| | feeling-problem | disappointed, report is poor quality |
| | solution-type | refund or exchange |
| | feeling-solution | entitled & hopeful, want case to be |
| | | quickly resolved |

### Use cases: Compare Complaint with Business Rules

Table 8 shows the result of comparing the well-formed complaints in Table 7 with the rules in Table 5. When a consumer has specified multiple acceptable types of solutions, the precedence ordering of the business rules is used to select the solution most favored by the merchant. Complaint management system 10 would actually compare the complaint only with the rules for the merchant named in the complaint, that is the complaint for consumers 40, 41, 42 with the rules for merchants 20, 21, 22, respectively.

TABLE 8

| | Merchant 20 | Merchant 21 | Merchant 22 |
|---|---|---|---|
| Consumer 40 | NO MATCH | exchange | refund |
| | | | & (shipping-to-consumer = |
| | | | will refund) |
| | | | & (return-shipping = will |
| | | | refund) |
| Consumer 41 | refund | refund | exchange |
| | | | & bonus = “10% off higher |
| | | | value exchange item” |
| | | | & (shipping-to-consumer = |
| | | | will refund) |
| | | | & (return-shipping = will |
| | | | refund) |
| Consumer 42 | exchange | refund | exchange |
| | & (return- | | & (shipping-to-consumer = |
| | shipping = | | will refund) |
| | will refund) | | & (return-shipping = will |
| | | | refund) |
| | | | & bonus = free gift |

In the case of consumer 40's complaint against merchant 20, complaint management system 10 detects that there is no match between the consumer's desired solution and the business rules applicable to the consumer's situation as set forth in the well-formed complaint. Accordingly, this case proceeds to automated mediation. Since one of the business rules applies to the consumer's situation, complaint management system 10 uses the solutions in the applicable business rule to generate merchant 20's Answer to consumer 40's Complaint:

exchange & (return-shipping=won't refund)) or

credit & (text-message=“Good for one year”) & (return-shipping=won't refund)

In all other cases, complaint management system 10 automatically resolves the consumer's complaint because there is a match between the consumer's desired solution and the business rules applicable to the consumer's situation as set forth in the well-formed complaint. In some cases, there are multiple matches, and the merchant's precedence ordering is used to select the type of solution in the automatic resolution.

### Use cases: Automated Mediation

For the complaint from consumer 40 against merchant 20, complaint management system 10 prepares a well-formed Answer via FIG. 8A steps 715 and 720. Table 9 shows the well-formed Answer; the left-hand column is provided for the convenience of the reader, that is, the well-formed Answer does not include the left-hand column.

TABLE 9

| | Well-formed Answer |
|---|---|
| Automatically | Case: 567832 |
| generated Answer | Date Answer sent: 02/22/01 |
| | ANSWER |
| | FROM MERCHANT 20 TO COMPLAINT FROM |
| | CONSUMER 40 |
| | Thank you for using this system to resolve your |
| | complaint. |
| | The complaint handling policy of merchant 20 does |
| | not match your desired solution, a REFUND. |
| | However, merchant 20 is agreeable to either of the |
| | following solutions: |

(1) an EXCHANGE, or
(2) a STORE CREDIT Good for one year

| | If you accept solution (1), please reply to this email |
|---|---|
| | with “accept (1)” as the first line of the message, and |
| | keeping the same subject line. |
| | If you accept solution (2), please reply to this email |
| | with “accept (2)” as the first line of the message, and |
| | keeping the same subject line. |
| | If you do not accept these solutions, please go to the |
| | following address and use the system to prepare your |
| | Reply: |
| | http://www.automatedsystem.com/cgi/? |
| | PrepareReply&case=567832 |
| | Or, you can go to web site 12, access your pending |
| | cases, and prepare your Reply from there. |
| | YOU MUST REPLY WITHIN TWO WEEKS OF |
| | TODAY, by March 8, 2001. If you do not reply by |
| | this date, you are ABANDONING your complaint, |
| | and the public record for merchant 20 will reflect that |
| | your complaint was SUCCESSFULLY RESOLVED. |
| Merchant-Text-4 | This is a form message from merchant 20: Please be |
| | aware that the above text was automatically created by |
| | the system based on my rules. Your satisfaction is |
| | important to me, and I hope this takes care of your |
| | problem. |

Assume that consumer 40 still wants a refund, so consumer 40 goes to web site 12 and prepares a Reply by interacting with complaint management system 10 operative according to FIG. 8C. Table 10 shows the well-formed Reply approved by consumer 40 for sending to merchant 20 as an e-mail message.

TABLE 10
Well-formed Reply

Case: 567832
Date Reply sent: 02/24/01

REPLY
FROM CONSUMER 40 TO MERCHANT 20

Thank you for answering my complaint (see copy below).
I appreciate your offer of an EXCHANGE, or a STORE CREDIT
Good for one year.
However, I wish to have a REFUND. I think this is fair because “your
clerk, the blond guy about 25 years old, told me that I could bring it
back if I didn't like it”.
I feel frustrated and angry, and want to be treated fairly and have this
problem resolved.
If you accept my solution of a REFUND, please reply to this email with
“accept” as the first line of the message, and keeping the same subject
line.
If you do not accept my solution, please go to the following address and
use the system to prepare your Sur-reply:
http://www.automatedsystem.com/cgi/?PrepareSurreply&case=567832
Or, you can go to web site 12, access your pending cases, and prepare
your Sur-reply from there.
YOU MUST SUR-REPLY WITHIN TWO WEEKS OF TODAY, by
March 10, 2001. If you do not sur-reply by this date, you are NON-
RESPONSIVE, and your public record will reflect that you DID NOT
RESPOND to a complaint.

COMPLAINT

| | |
|---|---|
| consumer ID | 40 |
| merchant ID | 20 |
| complaint filing date | 02/22/01 |
| problem-type | not as expected |
| item description | walnut/chrome floor lamps |
| item quantity | 2 |
| item-cost | $800 |
| purchase-date | 02/15/01 |
| sales-channel | store |
| feeling-problem | frustrated, wants to be treated fairly |
| solution-type | refund |
| feeling-solution | entitled, store clerk promised refund |

Merchant 20 receives the well-formed Reply shown in Table 10; this is the first time in this case that merchant 20 has had a human involved in resolution of this complaint. Complaint management system 10 has collected the complaint information for merchant 20, and automatically answered the complaint according to merchant 20's automated complaint handling policy. Complaint management system 10 has enabled consumer 40 to vent his or her emotions without any stress to merchant 20. By including emotional state information in each communication from consumer 40, complaint management system 10 provides merchant 20 with a snapshot of how consumer 40 feels, despite no personal involvement from merchant 20.

Assume that merchant 20 does not wish to make an exception to its policy and provide a refund, but realizes that consumer 40 is stuck on receiving a refund. Accordingly, merchant 20 uses web site 12 to prepare a well-formed Sur-reply, shown in Table 11, and send it to consumer 40 via e-mail.

TABLE 11
Well-formed Sur-reply
Case: 567832
Date Sur-Reply sent: 02/27/01
SUR-REPLY
FROM MERCHANT 20 TO COMPLAINT FROM CONSUMER 40

```
Thank you for using this system to resolve your complaint
I understand that you want a REFUND, and want to be treated fairly and
have this problem resolved.
I offer the following CUSTOM solution to your complaint:
    “You can have a store credit good for one year. If you use the
    store credit, you can have 25% off whatever you purchase as long
    as it is at least the value of your original purchase. If you don't use
    the store credit, at the end of the year, you can remind me about
    this and I will refund your purchase price.”
If you accept my CUSTOM solution, please reply to this email with
“accept” as the first line of the message, and keeping the same subject
line.
If you do not accept my solution, please go to the
following address and use the system to indicate that you do not accept,
and view your alternatives at this point:
http://www.automatedsystem.com/cgi/?SurreplyResponse&case=567832
Or, you can go to web site 12, access your pending cases, and respond
to my Sur-reply from there.
YOU MUST RESPOND WITHIN TWO WEEKS OF TODAY, by
March 13, 2001. If you do not respond by this date, you are
ABANDONING your complaint, and the public record for merchant
20 will reflect that your complaint was SUCCESSFULLY RESOLVED.
```

Assume that consumer 40 accepts the custom solution offered by merchant 20. Complaint management system 10 then notifies consumer 40 and merchant 20 that an agreement has been reached, and that consumer 40 should return the item by a specific date, such as Mar. 30, 2001, and that merchant 20 must act on its custom solution, herein, issue the credit, within two weeks after the date that the item is returned.

Following the compliance procedure shown in FIG. 9, complaint management system 10 obtains an e-mail affirmation from consumer 40 that the item has been returned. Merchant 20 confirms that the item was returned and affirms that the store credit was issued. Consumer 40 confirms that the store credit was received. The complaint has been successfully resolved, and complaint management system 10 closes the case.

### Use cases: Prepare Anonymized Case Summary

After a case is closed, complaint management system 10 prepares an anonymized summary of the case and archives the detailed case record. Assume the demographic information from consumer 40's registration 210 is as shown in Table 12, the demographic information from merchant 20's registration 220 is as shown in Table 13, and the case record is as shown in Table 14. Assume that the population of Evanston is 80,000 and the population of Atlanta is 1,200,000. Complaint management system 10 prepares the anonymized case summary shown in Table 15.

TABLE 12

| | Consumer Demographic Information |
|---|---|
| consumer ID | 40 |
| residence | Evanston, Illinois |
| dwelling unit | own house |
| sex | F |
| birth year | 1960 |
| income | $72,000 |
| marital status | divorced |
| household size | 3 |

TABLE 13

| | Merchant Demographic Information |
|---|---|
| merchant ID | 20 |
| location | Atlanta, Georgia |
| no. employees | 22 |
| in business since | 1998 |
| industry category | retail |
| revenue | $6,000,000 |
| no. stores | 4 |
| mail order sales | yes |
| Internet sales | yes |

TABLE 14

| | case record | |
|---|---|---|
| case ID | 567832 | |
| filing date | 2/22/01 | |
| consumer ID | 40 | |
| merchant ID | 20 | |
| complaint | consumer ID | 40 |
| | merchant ID | 20 |
| | complaint filing date | 02/22/01 |
| | problem-type | not as expected |
| | item description | walnut/chrome floor lamps |
| | item quantity | 2 |
| | item-cost | $800 |
| | purchase-date | 02/15/01 |
| | sales-channel | store |
| | feeling-problem | frustrated, wants to be treated |
| | | fairly |
| | solution-type | refund |
| | feeling-solution | entitled, store clerk promised |
| | | refund |

| | |
|---|---|
| business | 1. If ((not-as-expec or delivery or companion) |
| rules at start | & ((today-date - purchase-date) ≦ 30) |
| of case | ) |
| | then ((exchange & (return-shipping = won't refund)) |
| | or (credit & (text-message = “Good for one year”) |
| | & (return-shipping = won't refund)) |
| | ) |
| | 2. If (defective) |
| | then ((refund or credit or exchange) & (return-shipping = |
| | will refund) |
| | ) |
| | PREC: exchange > credit > refund > repair |
| system | v2001.3 |
| version | |
| procedural - | prepared by system on 2/22/01 |
| Answer | |
| Answer | ANSWER |
| attached | FROM MERCHANT 20 TO COMPLAINT FROM |
| | CONSUMER 40 |
| | Thank you for using this system to resolve your complaint. |
| | The complaint handling policy of merchant 20 does |
| | not match your desired solution, a REFUND. However, |
| | merchant 20 is agreeable to either of the following |
| | solutions: |
| | (3) an EXCHANGE, or |
| | (4) ‘[ |
| | (5) a STORE CREDIT Good for one year |
| | If you accept solution (1), please reply to this email with |
| | “accept (1)” as the first line of the message, and keeping |
| | the same subject line. |
| | If you accept solution (2), please reply to this email with |
| | “accept (2)” as the first line of the message, and |
| | keeping the same subject line. |
| | If you do not accept these solutions, please go to the |
| | following address and use the system to prepare your |
| | Reply: |
| | http://www.automatedsystem.com/cgi/?PrepareReply& |
| | case=567832 |
| | Or, you can go to web site 12, access your pending cases, |
| | and prepare your Reply from there. |
| | YOU MUST REPLY WITHIN TWO WEEKS OF |
| | TODAY, by March 8, 2001. If you do not reply by this |
| | date, you are ABANDONING your complaint, and the |
| | public record for merchant 20 will reflect that your |
| | complaint was SUCCESSFULLY RESOLVED. |
| procedural - | prepared by consumer on 2/24/01 |
| Reply | |
| Reply | REPLY |
| attached | FROM CONSUMER 40 TO MERCHANT 20 |
| | Thank you for answering my complaint (see copy below). |
| | I appreciate your offer of an EXCHANGE, or a STORE |
| | CREDIT Good for one year. |
| | However, I wish to have a REFUND. I think this is fair |
| | because “your clerk, the blond guy about 25 years old, |
| | told me that I could bring it back if I didn't like it”. |
| | I feel frustrated and angry, and want to be treated fairly |
| | and have this problem resolved. |
| | If you accept my solution of a REFUND, please reply |
| | to this email with “accept” as the first line of |
| | the message, and keeping the same subject line. |
| | If you do not accept my solution, please go to the following |
| | address and use the system to prepare your Sur-reply: |
| | http://www.automatedsystem.com/cgi/?PrepareSurreply& |
| | case=567832 |
| | Or, you can go to web site 12, access your pending cases, |
| | and prepare your Sur-reply from there. |
| | YOU MUST SUR-REPLY WITHIN TWO WEEKS OF |
| | TODAY, by March 10, 2001. If you do not sur-reply |
| | by this date, you are NON-RESPONSIVE, and your public |
| | record will reflect that you DID NOT RESPOND to |
| | a complaint. |
| procedural - | prepared by merchant on 2/27/01 |
| Sur- | |
| reply | |
| Sur-reply | |
| attached | SUR-REPLY |
| | FROM MERCHANT 20 TO COMPLAINT FROM |
| | CONSUMER 40 |
| | Thank you for using this system to resolve your complaint |
| | I understand that you want a REFUND, and want to be |
| | treated fairly and have this problem resolved. |
| | I offer the following CUSTOM solution to your complaint: |
| | “You can have a store credit good for one |
| | year. If you use the store credit, you can |
| | have 25% off whatever you purchase as |
| | long as it is at least the value of your |
| | original purchase. If you don't use the |
| | store credit, at the end of the year, you can |
| | remind me about this and I will refund |
| | your purchase price.” |
| | If you accept my CUSTOM solution, please reply to this |
| | email with “accept” as the first line of the message, |
| | and keeping the same subject line. |
| | If you do not accept my solution, please go to the following |
| | address and use the system to indicate that you do not |
| | accept, and view your alternatives at this point: |
| | http://www.automatedsystem.com/cgi/?SurreplyResponse& |
| | case=567832 |
| | Or, you can go to web site 12, access your pending cases, |
| | and respond to my Sur-reply from there. |
| | YOU MUST RESPOND WITHIN TWO WEEKS OF |
| | TODAY, by March 13, 2001. If you do not respond by |
| | this date, you are ABANDONING your complaint, and |
| | the public record for merchant 20 will reflect that |
| | your complaint was SUCCESSFULLY RESOLVED. |
| procedural - | prepared by consumer on 3/1/01, agreement reached |
| Sur- | |
| reply | |
| Decision | |
| Sur-reply | accept |
| Decision | |
| attached | |
| Comp- | consumer affirmed 3/5/01 |
| liance - | |
| Consumer | merchant confirmed 3/8/01 |
| Comp- | merchant affirmed 3/8/01 |
| liance - | |
| Merchant | consumer confirmed 3/22/01 |
| Status | Complaint successfully resolved |

TABLE 15

| | Anonymized case summary | | |
|---|---|---|---|
| case ID | 567832 | | |
| consumer | city | 50,000-100,000 | |
| demographic | dwelling unit | own | |
| Level I | sex | F | |
| | age | 30-35 | |
| | income | $50,000-75,000 | |
| | marital status | single (includes divorced, widowed) | |
| | household size | 2-5 | |
| consumer | city | Evanston, Illinois | |
| demographic | dwelling unit | own house | |
| Level II | sex | F | |
| | age | 1960 | |
| | income | $72,000 | |
| | marital status | divorced | |
| | household size | 3 | |
| merchant | location | 1,000,000-5,000,000 | |
| demographic | no. employees | 10-50 | |
| Level I | years in business | 4-10 | |
| | industry category | retail | |
| | revenue | $1,000,000-10,000,000 | |
| | stores | yes | |
| | mail order sales | yes | |
| | Internet sales | yes | |
| merchant | location | Atlanta, Georgia | |
| demographic | no. employees | 22 | |
| Level II | years in business | 4 | |
| | industry category | retail | |
| | revenue | $6,000,000 | |
| | no. stores | 4 | |
| | mail order sales | yes | |
| | Internet sales | yes | |
| procedural | Complaint | filing date | 02/01 |
| history | | problem-type | not as expected |
| Level I | | item | product |
| | | item-cost | $500-1,000 |
| | | purchase-date | filing - (up to |
| | | | 1 week) |
| | | sales channel | store |
| | | problem-feeling | frustrated |
| | | solution | refund |
| | | solution-feeling | entitled |
| | Answer | date | filing |
| | | solution | exhange or credit |
| | Reply | date | filing + |
| | | | (1-3 days) |
| | | solution | refund |
| | Sur-Reply | date | filing + |
| | | | (4-7 days) |
| | | solution | custom |
| | Sur-Reply | date | filing + |
| | | | (4-7 days) |
| | Decision | type | accept |
| | Compliance | yes | |
| | Status | complaint successfully resolved | |
| procedural | Complaint | filing date | 02/22/01 |
| history | | problem-type | not as expected |
| Level II | | item | lamp |
| | | item-cost | $800 |
| | | purchase-date | filing - 7 days |
| | | sales-channel | store |
| | | problem-feeling | frustrated |
| | | solution | refund |
| | | solution-feeling | entitled |
| | Answer | date | filing + 0 days |
| | | generated by | |
| | | solution | exchange or |
| | | | credit |
| | Reply | date | filing + 2 days |
| | | solution | refund |
| | | solution-feeling | frustrated, angry |
| | Sur-Reply | date | filing + 5 days |
| | | solution | custom, store |
| | | | credit, refund |
| | Sur-Reply | date | filing + 7 days |
| | Decision | type | accept |
| | Compliance | consumer date | filing + 11 days |
| | | cons'r affirmed | consumer |
| | | by | |
| | | merchant date | filing +14 days |
| | | merch. affirmed | merchant |
| | | by | |

| | | |
|---|---|---|
| | Status | complaint successfully resolved |
| resolution | custom | |
| description | | |
| Level I | | |
| resolution | consumer | return item, no return shipping |
| description | merchant | custom, store credit, refund |
| Level II | | |

Complaint management system 10 also provides an interface (not shown) for each registered member, consumers and merchants, to update their registration information and manage their complaints.

In some embodiments, complaint management system 10 provides an interface for human-directed dispute resolvers to manage their pending case referrals.

In some embodiments, complaint management system 10 also provides a marketplace for human-directed dispute resolution services to bid on cases based on the nature of the case, how far apart the parties are in their negotiating positions and other suitable parameters. More specifically, dispute resolvers register with complaint management system 10 to receive synopses of cases desiring mediation, and submit bids of how quickly they can take the case and/or their fee for mediating the case. Complaint management system 10 uses a predetermined procedure to select the dispute resolver, such as high bidder subject to veto by one of the parties, or other procedure.

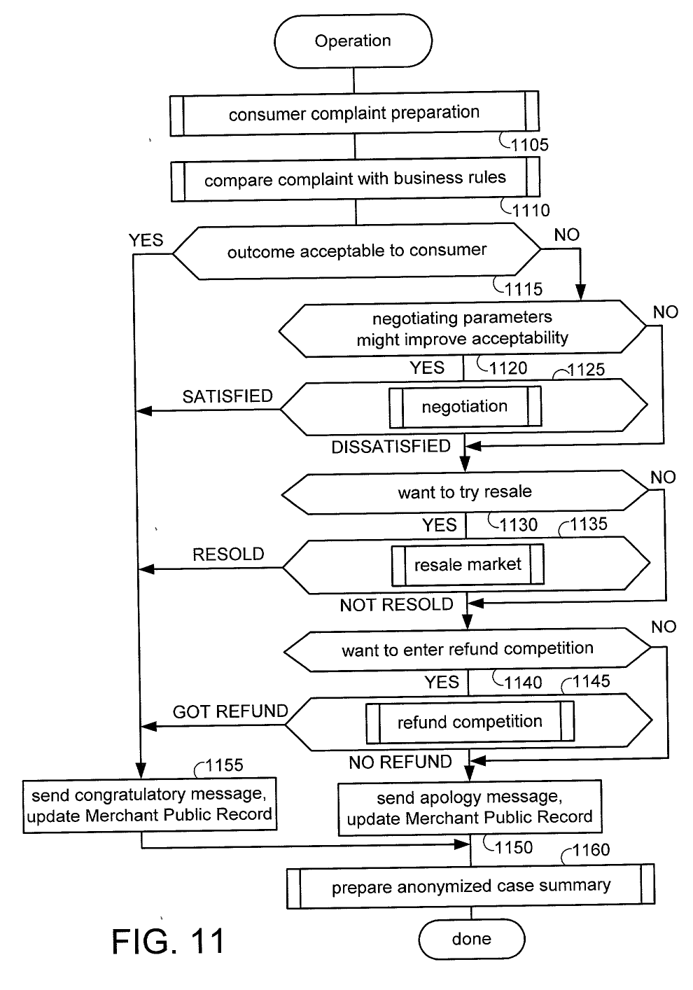

FIG. 11 depicts operation of system 10 in another embodiment. When the consumer complains about an intangible item, such as downloading of information, the right to use a telecommunications service, or the right to a future service such as a concert or airline ticket, the complaint resolution process need not confirm whether the consumer or merchant actually shipped an item. Rather, the merchant can specify what to do under specific circumstances, and complaint management system 10 can automatically provide the remedies specified by the merchant.

In this example, let it be assumed that the merchant is selling tickets. When a customer is unhappy with their purchase, perhaps because their plans changed or they disliked the seat location, the merchant will provide cancel the purchased ticket and provide a credit for a future ticket purchase. The merchant has configured system 10 to enable the consumer to negotiate the duration of the credit to make the consumer happier. For consumers that want a refund rather than a credit, the merchant provides a secondary resale market, to help consumers resell their tickets for a refund less a resale processing fee, and also provides a refund competition, so that the most deserving cases can get a limited pool of refund money.

System 10 thus enables consumers to have some control over their remedy, indicating respect for the consumer. Because the negotiation process is affected by the consumer's feelings, the merchant demonstrates that it cares about the consumer's feelings. Because consumers vote on which cases deserve refunds, the refund allocation process seems fair, and does not exclude deserving cases merely because they deviated from a set of pre-established criteria.

Step 1105, consumer complaint preparation, and step 1110, comparing the complaint with business rules, of FIG. 11 are generally similar to steps 410 and 415 of FIG. 5, respectively, and are not discussed for brevity. However, in this example, let it be assumed that the merchant has configured its rules so that at least one of the rules will always be triggered, for example:

If (today's_date<ticket_event_date) then (offer credit good for(ticket_event_date−today's_date)days) (Rule 11 A)

If (today's date≧ticket_event_date) then (offer apology) (Rule 11 B)

Thus, either an Agreement will exist or an Answer will be automatically generated at the end of step 1110. In other words, step 1110, comparing the complaint with business rules, always produces a proposed remedy; it will be appreciated that, in this sense, the remedy may be simply an apology or a notice that none of the consumer's desired remedies can be provided.

At step 1115, system 10 determines whether the outcome is acceptable to the consumer, such as by asking the consumer if this solution is satisfactory through a dialog box presented on a web page. A purpose of asking the consumer is to demonstrate that the consumer's feelings are important to the merchant. Another purpose of asking the consumer is to give the consumer some control over the complaint management process. If the consumer indicates satisfaction, processing proceeds to step 1155. If the consumer is not satisfied, at step 1120, system 10 inquires whether negotiating the parameters of the solution offered might improve acceptability of the solution. For example, through a dialog box on a web page, system asks the consumer, “You are not satisfied with a credit good for 3 days. If the credit was good for a longer time, might you be satisfied?” If the consumer answers negatively, processing proceeds to step 1130.

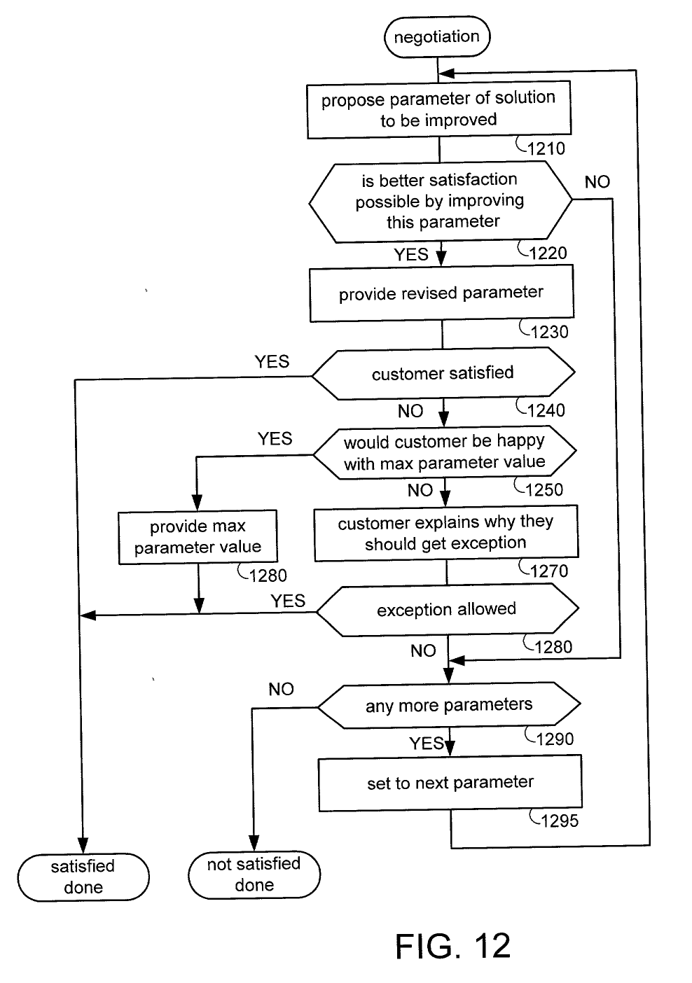

If the consumer answers that negotiating the parameters might produce an acceptable solution, then processing proceeds to step 1125 for automated negotiation as shown in FIG. 12. By enabling negotiation, the merchant indicates concern for the consumer. If the consumer is satisfied by the negotiation, processing proceeds to step 1155. If the consumer is not satisfied and the ticket event date is in the future, at step 1130, system 10 inquires whether the consumer wants to have system 10 try to resell their ticket for a resale fee. If the consumer answers negatively or the ticket event date is not in the future, processing proceeds to step 1140.

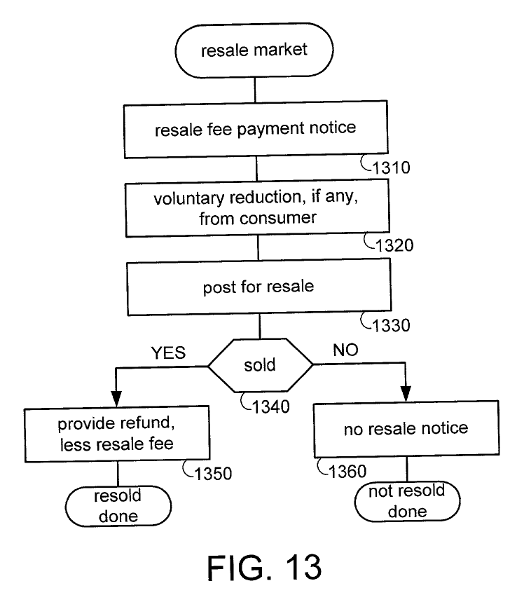

If the consumer answers that system 10 should try to resell the ticket, then processing proceeds to step 1135 for use of the resale market as shown in FIG. 13. By providing a resale market, the merchant indicates that it wishes to help the consumer. If the consumer's ticket is resold, processing proceeds to step 1155. If the consumer's ticket was not resold, or the consumer was unhappy but did not or could not try the resale market, at step 1140, system 10 inquires whether the consumer wants to enter a refund competition. If the consumer answers negatively, processing proceeds to step 1150.

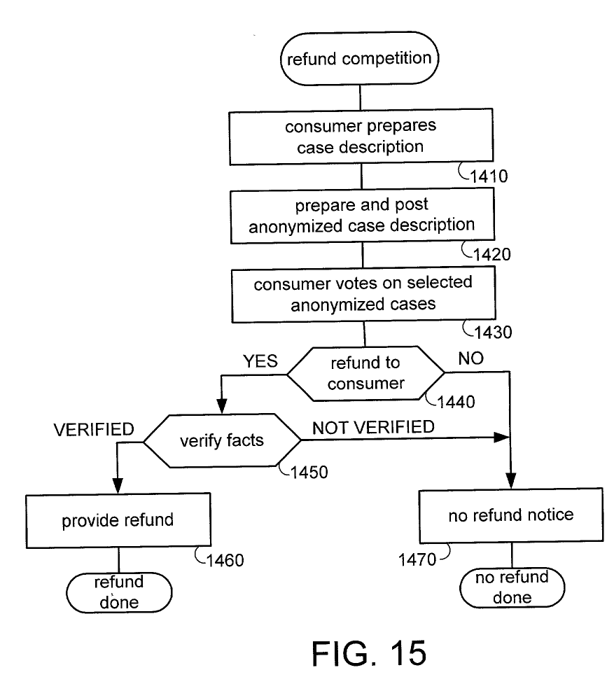

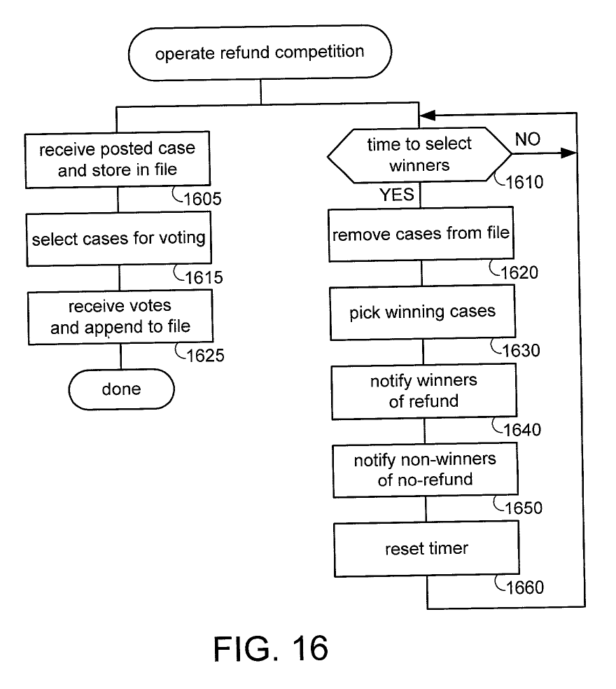

If the consumer wishes to enter a refund competition, then processing proceeds to step 1145 for the refund competition as shown in FIG. 15. By providing a refund pool, the merchant indicates it understands that some consumers have exceptional cases that deserve refunds irregardless of policy. By having the refunds distributed on the basis of consumer votes, consumers perceive the distribution mechanism as fair, similar to the public justice jury system. Since the consumers are doing the work of deciding which cases deserve refunds, the administration overhead of distributing refunds is low. If the consumer wins the refund competition, processing proceeds to step 1155. If the consumer did not win the refund competition, processing proceeds to step 1150.

At step 1150, system 10 sends an apology message to the consumer and updates the merchant's public record to reflect that an Agreement was reached, and processing proceeds to step 1160.

At step 1155, system 10 sends a congratulatory message to the consumer and updates the merchant's public record to reflect that an Agreement was not reached.

At step 1160, system 10 prepares an anonymized case summary in a generally similar manner as described with regard to step 430 of FIG. 5.

FIG. 12 shows the negotiation procedure used in automated complaint management system 10. To be appropriate for the negotiation procedure of FIG. 12, a remedy provided by the merchant must have parameters that can be varied, and the merchant must be willing to vary the parameters to improve the customer's satisfaction. For example, a credit for a ticket can be defined as having four parameters: (i) the date by which the credit must be used, (ii) the date by which the event being ticketed must occur, (iii) the amount of the credit, (iv) who can use the credit, that is, whether it is transferable.

As an example, assume that the customer's plans changed, and so the customer does not want a ticket they purchased. Assume also that the customer is using complaint management system 10 two weeks before the date of the ticketed event. Further assume that the merchant's rules initially authorized system 10 to offer a credit good for two weeks, for an event within one month of the credit exercise date, and that the credit was non-transferable. The negotiation process of FIG. 12 enables the customer to obtain an improvement in each of the parameters of the credit without affirming satisfaction, but requires an affirmation of satisfaction to provide the maximum parameter value that the merchant permits. For example, the first iteration of the negotiation procedure offers the opportunity to make the credit transferable; the second iteration of the negotiation procedure allows the consumer to remove a processing fee from the credit so as to obtain a credit for the full value of the ticket; the third iteration of the negotiation procedure enables the consumer to extend the credit exercise date from two weeks to one month, and then to one year if that would make the consumer happy; and the fourth iteration of the negotiation procedure enables the consumer to extend the event occurrence date from one month to three months.

Using the negotiation procedure of FIG. 12, the consumer feels as if they are steadily scoring victories against system 10, in exchange for asserting they are becoming more satisfied, which demonstrates that their feelings matter. In contrast, if the merchant immediately offered its maximum permissible parameters, the consumer would not earn their victorious feeling, and would not be getting something for becoming more satisfied.

Conventional price negotiation “bots” employed at web sites engage the consumer in a dialog wherein the consumer is encouraged to keep offering higher offers for an item until a minimum threshold is met. In contrast, system 10 offers parameter adjustment in exchange for the consumer's improved feelings.

At step 1210, system 10 proposes a parameter to be improved, such as the credit exercise date. At step 1220, system 10 determines whether improvement in this parameter might result in more satisfaction, such as by inquiring via a web dialog box pop-up on a web page. If not, processing proceeds to step 1290.

If improving this parameter might result in more satisfaction, at step 1230, system 10 provides improvement, such as by doubling the time until the credit exercise date. At step 1240, system 10 checks whether this has resulted in a satisfied customer, such as by inquiring via a web dialog box pop-up on a web page. If the customer is satisfied, the negotiation is complete.

If the customer is not satisfied, then at step 1250, system 10 discloses the maximum value of the parameter that it is authorized to provide, and inquires whether this would result in customer satisfaction. In some embodiments, system 10 iterates steps 1230 and 1240 before step 1250. If this would satisfy the customer, then system 10 provides the maximum value, and the negotiation is complete.

If the maximum value of the parameter would not satisfy the customer, then at step 1270, system 10 gives the customer an opportunity to explain why they should get more than the maximum authorized value. This is akin to preparing a Reply in the automated mediation procedure described above at step 740 of FIG. 8A. System 10 delivers this explanation to merchant 10, for a review and a decision, akin to preparing a Sur-reply as described above at step 750 of FIG. 8A. In some embodiments, the merchant may configure system 10 so as to omit steps 1270 and 1280. If, at step 1280, the merchant agrees with the consumer, then the negotiation is complete. If the merchant did not agree with the consumer, processing proceeds to step 1290.

At step 1290, system 10 checks whether there are any more parameters for the remedy offered. If so, at step 1295, system 10 sets itself to the next parameter, and processing returns to step 1210 to explore improving the next parameter.

When there are no more parameters left to explore, the negotiation is complete.

FIG. 13 shows resale market processing.

At step 1310, system 10 provide a notice to the consumer regarding how the resale market works, including the fee charged by the merchant to accept the consumer's ticket into the resale market, or the fee assessed to a resale. At step 1320, system 10 inquires whether the consumer would like to voluntarily reduce the price of their ticket to improve its resale chances, and adjusts the price of the ticket for any amount the consumer has provided. For example, if the ticket cost was $100, the consumer may elect to absorb a $20 loss and sell the ticket for $80, to improve its attractiveness and the consumer's chance of getting immediate money.

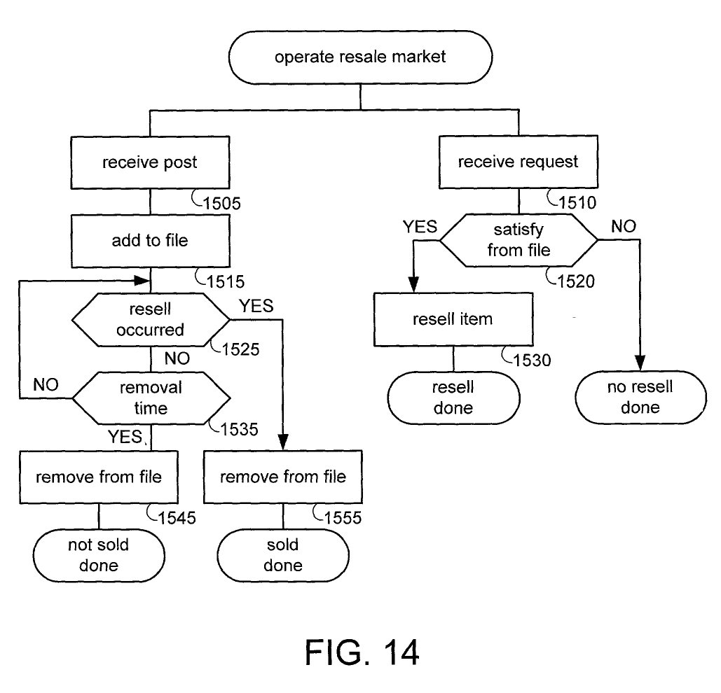

At step 1330, system 10 posts the ticket to the resale market, shown in FIG. 14. At step 1340, system 10 determines whether the ticket was sold. If so, then at step 1350, system 10 provides a refund in the appropriate amount, and processing is complete. If the ticket was not sold, then system 10 provides a notice of this fact to the consumer and processing is complete.

FIG. 14 shows operation of a resale market. System 10 performs two types of processing to operate the resale market. First, system 10 receives posts from consumers, adds the posts to its file, and then removes the posts at an appropriate expiration time or when the posted item has been sold. Second, system 10 receives requests for items, such a “first look” from the merchant's system that sells the items, and determines whether the request can be satisfied from its file.

At step 1505, system 10 receives a post of an item, such as a post generated at step 1330 of FIG. 13. At step 1515, system 10 adds the post to its posted items file. At step 1525, system 10 checks whether there is a notice that item has been sold, such as the notice generated at step 1530 (see below). If so, at step 1555, system 10 removes the item from its posted items file and processing is complete. If the item has not been sold, at step 1535, system 10 determines whether it is time to remove the item from its posted items file. For example, if the current date is after the event date of the ticket, then the item should be removed. If the item should be removed, at step 1545, system 10 removes the item and processing is complete. If it is not yet time to remove the item from the posted items file, then processing returns to step 1525.

At step 1510, system 10 receives a request for a particular item. At step 1520, system 10 checks whether the request can be satisfied from its posted items file. If not, processing is complete. If the request can be satisfied from its posted items file, then at step 1530, system 10 generates a notice that the item was sold for step 1525, notifies the requester that an appropriate item is now theirs, and processing is complete.

FIG. 15 shows refund competition processing.

At step 1410, the consumer prepares a text description of their case focusing on what circumstances make them particularly deserving of a refund. In some embodiments, the 250 consumer is required to provide a minimum number of words in their case description, such as 250. Preparation of their case description encourages a consumer to vent their feelings of anger, injustice and so forth, in a controlled manner. The resulting description may help the consumer realize that the merchant is not at fault, but rather serves as a focus for frustration about other things in the consumer's life. Further, since the consumer knows other people will read their description during their voting, the consumer is assured that the consumer will be heard, and the community will, at least in a small way, share their problems. The text description is advantageously provided through a text entry field on a web page.

At step 1420, system 10 anonymizes the case description provided by the consumer at step 1410. Here, anonymization comprises masking identifying information in the case description, such as telephone numbers, street addresses and so on. In some embodiments, anonymization also includes substituting common nouns for proper nouns, in particular, a specific performance, e.g., “Metallica concert” may be anonymized to “ROCK GROUP concert”, usually with a note appended to indicate that anonymization occurred.

An anonymized case description is used for voting in the refund competition. An anonymized case summary is used to understand the complaint management process. An anonymized case summary includes the anonymized case description, if any, generated during processing of a particular complaint case.

At step 1430, system 10 presents the consumer with a selected set of anonymized cases, and the consumer votes on which deserve refunds. In a modification, the consumer rank orders the cases according to which are the most deserving. In some embodiments, the consumer gets, e.g., three votes for each batch of ten cases they review. In a modification, the consumer gets a first predetermined number of positive votes and a second predetermined number of negative votes, and must cast at least a third predetermined number of votes either positive or negative. In some embodiments, the consumer's anonymized case is always included in the batch presented to the consumer. Voting provides a sense of control to the consumer. Reviewing other people's cases provides perspective to the consumer and helps them form more realistic expectations. The consumer community acts as a third-party neutral, so the process is perceived as fair. The administrative burden on the merchant is fairly low, since the consumers and system 10 are doing the work of deciding which cases are most deserving of refunds.

At step 1440, system 10 checks whether this consumer was awarded a refund. It will be appreciated that this step may be delayed relative to the previous step, e.g., for a week or a month, to give system 10 time to expose the consumer's case to voting. If a refund was awarded, at step 1450, the consumer must provide proof of the circumstances mentioned in their case. If proof is provided, the case is verified and at step 1460, a refund is provided to the consumer. It will be understood that the refund at step 1460 is typically provided from the merchant's account. If the consumer failed to submit proof of their circumstances, or a refund was not awarded, then at step 1470, the consumer is notified that they did not receive a refund.

FIG. 16 shows operation of a refund competition. System 10 performs two types of processing to operate the refund competition. First, system 10 receives an anonymized case description from a consumer, presents the consumer with a set of anonymized cases to vote on, and stores the votes. Second, at predetermined intervals, system 10 removes a batch of anonymized cases, selects certain cases for refunds, and notifies the associated consumers whether or not they have won a refund.

At step 1605, system 10 receives an anonymized case description and stores the case description in its file of competing cases, such as from step 1420 of FIG. 15. At step 1615, system 10 selects cases for voting according to an exposure procedure. The exposure procedure tries to give an equal number of exposures to each case, and to have a case compared against different cases each time. One example of an exposure procedure is to randomly pick cases, exclude previously compared cases from the batch and randomly pick a replacement to arrive at a full batch size for voting, e.g., ten cases. Another example of an exposure procedure is to select cases according to a “widening comb” procedure: select every other case until a full batch is formed, then for the next batch, select every second case until a full batch is formed, then for the next batch, select every third case until a full batch is formed, and so on, to avoid the same cases being compared. At step 1625, system 10 receives the votes from the consumer and stores the votes. In some embodiments, the votes are stored with the case, and in other embodiments, the votes are stored in a separate vote file. Generally, system 10 is configured to capture, for each case, the event of a positive vote, the event of an exposure with no vote, and the event of a negative vote.

At step 1610, system 10 checks a selection timer to determine whether it is time to select a batch of cases and award refunds. If not, processing returns to step 1610. The selection timer checked by system 10 is configurable by the merchant to count either a number of cases or elapsed time. Further, the merchant can specify how its refund pool will be allocated: either a fixed refund amount to be distributed to each batch, or a fixed number of cases to be selected from each batch, or some combination thereof. In a modification, after system 10 selects cases for refunds, the merchant may wish to manually review the selections and possibly adjust the selected cases.

When the selection timer indicates that it is time to select refund winners, at step 1620, system 10 removes a batch of cases from the competing cases file. At step 1630, system 10 selects the winning cases. For example, the merchant may configure system 10 to select, on a weekly basis, the four cases with the highest number of votes as winning refunds. System 10 performs normalization to determine the highest number of votes by dividing the number of positive votes for each case by the number of exposures for the case. Negative votes, if allowed, may have equal or different weight than positive votes. At step 1640, system 10 notifies the winning cases of their status. At step 1650, system 10 notifies the non-winning cases of their status. The notice provided at step 1640 is 1650 is what is checked at step 1440 of FIG. 15. At step 1660, system 10 resets the selection timer, and processing returns to step 1610.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A method for automated resolution of a complaint from a complainer against a party, comprising:
detecting lack of agreement between the complainer and the party, and
automatically mediating between the complainer and the party to resolve the complaint, the mediating occurring without a human mediator.

2. The method of claim 1, further comprising presenting relevant contextual information to the complainer during preparation of the complaint.

3. The method of claim 1, wherein the relevant contextual information is based on a set of advisory rules.

4. The method of claim 1, further comprising:
automatically collecting emotional detail information, and
automatically generating emotional state information for the complaint from the emotional detail information.

5. The method of claim 1, further comprising automatically determining what information is needed to detect lack of agreement based on information previously supplied by the party, and automatically collecting the needed information.

6. The method of claim 5, wherein the previously supplied information includes values for parameters relating to the complainer or to a subject of the complaint.

7. The method of claim 1, wherein detecting lack of agreement includes comparing the complaint with rules of the party.

8. The method of claim 1, further comprising automatically generating the party's answer to the complaint.

9. The method of claim 8, wherein generating the party's answer to the complaint occurs when the complaint's desired solution does not match acceptable solutions specified in rules of the party.

10. The method of claim 1, wherein automatically mediating includes collecting response information and preparing a well-formed response based on the collected response information.

11. The method of claim 10, wherein the response information includes emotional detail information and the well-formed response includes emotional state information.

12. The method of claim 1, wherein automatically mediating includes suggesting a response.

13. The method of claim 12, wherein automatically mediating includes collecting response information, and the suggested response is based on the collected response information.

14. The method of claim 1, further comprising automatically monitoring compliance by at least one of the complainer and the party with terms of an agreement resolving the complaint.

15. The method of claim 14, wherein automatically monitoring compliance includes receiving compliance information from at least one of the complainer and the party.

16. The method of claim 14, wherein automatically monitoring compliance includes receiving compliance information from an external source.

17. The method of claim 1, further comprising automatically preparing a summary of processing of the complaint.

18. The method of claim 17, wherein the summary is anonymized.

19. The method of claim 17, wherein the summary has at least two levels of information granularity.

20. A method for automated resolution of a complaint from a complainer against a party, comprising:
automatically collecting emotional detail information,
automatically generating emotional state information for the complaint from the emotional detail information, and
automatically comparing the complaint with rules previously supplied by the party to detect whether there is a match between a solution desired by the complainer and solutions that the party agrees to.

21. A method for automated resolution of a complaint from a complainer against a party, comprising:
automatically collecting the complaint from the complainer, and
when the complaint's desired solution does not match acceptable solutions specified in rules of the party, automatically generating a complaint resolution offer on behalf of the party based on the acceptable solutions specified in the rules of the party.

22. A method for automated resolution of a complaint from a complainer against a party, comprising:
obtaining an agreement resolving the complaint, and
automatically monitoring compliance by at least one of the complainer and the party with terms of the agreement.

23. The method of claim 22, wherein automatically monitoring compliance includes receiving compliance information from at least one of the complainer and the party.

24. The method of claim 22, wherein automatically monitoring compliance includes receiving compliance information from an external source.

25. A method for managing a complaint, comprising:
automatically comparing the complaint with merchant rules to obtain a proposed remedy having at least one parameter, and
automatically negotiating the at least one parameter of the proposed remedy to improve consumer satisfaction.

26. The method of claim 25, wherein negotiating includes improving one of the parameters of the remedy in response to an indication from a consumer that consumer satisfaction might be improved by improving the parameter.

27. The method of claim 26, further comprising additionally improving the improved parameter in response to a promise of satisfaction from the consumer.

28. The method of claim 26, further comprising automatically soliciting an explanation from the consumer as to why the consumer deserves parameter improvement beyond a predetermined value.

29. The method of claim 25, wherein negotiation includes automatically soliciting an explanation from the consumer as to why the consumer deserves parameter improvement beyond a predetermined value.

30. The method of claim 25, further comprising automatically submitting an item specified in the complaint to a resale market.

31. The method of claim 25, further comprising automatically entering an item specified in the complaint to a refund competition.

32. The method of claim 31, further comprising automatically receiving a description of circumstances justifying a refund of the price of the item specified in the complaint.

33. The method of claim 32, further comprising automatically anonymizing the description of circumstances.

34. The method of claim 31, further comprising automatically receiving a voting or ranking for a set of descriptions provided by other consumers.

35. The method of claim 34, further comprising automatically selecting the set of descriptions according to an exposure procedure.

36. The method of claim 25, further comprising automatically preparing an anonymized case summary of how the complaint was processed.

37. A method for managing a complaint, comprising:
automatically comparing the complaint with merchant rules to obtain a proposed remedy having at least one parameter, and
automatically entering an item specified in the complaint to a refund competition when the proposed remedy is not satisfactory.

38. The method of claim 37, further comprising automatically preparing an anonymized case summary of how the complaint was processed.

39. The method of claim 37, further comprising automatically receiving a description of circumstances justifying a refund of the price of the item specified in the complaint.

40. The method of claim 39, further comprising automatically anonymizing the description of circumstances.

41. The method of claim 37, further comprising automatically receiving a voting or ranking for a set of descriptions provided by other consumers.

42. The method of claim 41, further comprising automatically selecting the set of descriptions according to an exposure procedure.
